(19) United States
(12) Patent Application Publication
(10) Pub. No.: US 2025/0251244 A1
(43) Pub. Date: Aug. 7, 2025

(54) NAVIGATION ROAD-GRAPH AND PERCEPTION LANE-GRAPH MATCHING

(71) Applicant: NVIDIA Corporation, Santa Clara, CA (US)

(72) Inventor: Robert NIEWIADOMSKI, Seattle, WA (US)

(21) Appl. No.: 18/430,221

(22) Filed: Feb. 1, 2024

(51) Int. Cl. G01C 21/30; G06V 20/56; G08G 1/16

(52) U.S. Cl. CPC G01C 21/30; G06V 20/588; G08G 1/167

(57) ABSTRACT

In various examples, embodiments are directed to navigation-road and perception-lane matching for autonomous and semi-autonomous systems and applications. In this regard, lane-road matching is performed using geometric similarity to generate effective lane-road mappings for use in lane planning and decision making, among other things. In some embodiments, road data representing at least one road section and lane data representing a lane associated with a location of an ego-machine are received. Thereafter, a determination is made that one or more consecutive road sections match a lane based at least on a geometric similarity between the lane and the one or more consecutive road sections. A representation of the lane being mapped to the one or more consecutive road sections is generated based at least on the determining that the one or more consecutive road sections matched the lane.

### BACKGROUND

Designing a system to safely drive a vehicle autonomously without supervision or semi-autonomously with limited supervision is tremendously difficult. For example, some designs seek to have an autonomous vehicle or other ego-machine be capable of performing as a functional equivalent of an attentive driver—who draws upon a perception and action system that has an incredible ability to identify and react to dynamic and static obstacles in a complex environment—to avoid other objects or structures along the path of the vehicle. In designing such a system, lane graphs may be used, for example, to facilitate localization (e.g., positioning an ego-machine in a map), path planning (e.g., determining candidate routes for an ego-machine), object detection and tracking (e.g., for performing object in path analysis (OIPA), etc.), and/or decision making (e.g. determining an optimal route based on the candidate paths, vehicle state, and environment). For example, a lane graph may be used in lane planning to make decisions about lane changes, turns, and lane-keeping. Lane planning in the context of autonomous vehicles is valuable for many reasons including, among other things, following planned routes and making turns to navigate in an organized manner, performing efficient maneuvers, and facilitating lane-keeping assistance. Accordingly, accurate lane graphs are valuable for effectively facilitating localization, path planning, and/or decision making.

In some cases, however, a lane graph may not have adequate data reflected in the lane graph, thereby impacting the effectiveness of the lane graph (e.g., for use in performing lane planning). For example, a lane graph may have inaccurate or incomplete lane widths, markings, or other attributes that may result in suboptimal lane planning and navigation decision-making. Accordingly, planning and decision-making using such lane graphs may result in inaccurate or inefficient information, thereby limiting the ability to effectively navigate an autonomous vehicle through an environment.

### SUMMARY

Embodiments of the present disclosure relate to navigation-road and perception-lane matching for autonomous and semi-autonomous systems and applications. Systems and methods are disclosed that that use geometric similarity to identify or detect instances of lanes matching roads, or portions thereof, for use in localization, navigation, and/or other uses by autonomous vehicles, semi-autonomous vehicles, robots, and/or other object or machine types.

In contrast to conventional systems, such as those described above, in some embodiments, lane-road matching is performed using geometric similarity to generate effective lane-road mappings that may be used for lane planning and decision making, among other things, in autonomous or semi-autonomous systems and applications. For example, using techniques provided herein, lane-road mappings may be generated for use in generating effective lane-level instructions and for use by a behavior-planning module to perform efficient and effective navigation. In addition, lanes may be annotated with road-level attributes from a road-graph, including road curvature values and traffic-control signs and signals, thereby resulting in more detailed and effective information.

At a high level, embodiments described herein are directed to matching a lane to a road, or portions thereof, and generating a lane-road mapping representing the matching. In embodiments, a lane and a road, or portions thereof, may be identified as matching based on a geometric similarity analysis. In particular, a lane may be identified as matching a road, or portions thereof, when certain match conditions specifying geometric similarity are satisfied. For example, match conditions indicating a match of a lane to a road, or portions thereof, may include the lane being within a distance threshold and/or a direction threshold of the road. In determining that a geometric similarity between a lane and road, or portions thereof, indicates a match, a match score may be generated to indicate an extent of such geometric similarity. As a lane may be determined to match with multiple roads (e.g., in accordance with attaining matching conditions), the match score may be used to select a particular road to map to the lane. In this way, a particular lane matching a road, or portions thereof, in association with a greatest match score may be selected for a lane-road mapping. As such, a lane-road mapping generally maps a particular lane section(s) to a road section(s) that maximizes geometric similarity (e.g., based on the match score(s)). The lane-road mapping may be represented in any number of ways. In some cases, the lane-road mapping may be represented using a lane section identifier(s) and a road section identifier(s) that correspond with a location(s) in which the lane is determined to match a road.

In operation, to identify whether a lane matches a road, or portions thereof, various points along a lane and a road may be analyzed to determine that a set of match conditions are met, indicating geometric similarity between the lane and the road. One example of a match condition includes a lane being within a distance threshold to a road. For instance, when a lane is within a predetermined distance to a road, the lane may be considered to match the road. In some cases, to identify whether a distance condition is met, a perpendicular span extending from a lane and/or a road may be analyzed (e.g., via a lane-graph and/or road-graph). For instance, a perpendicular line may be extended from a road being analyzed until it intersects with a lane being analyzed. A distance from the road to the intersection may be determined and compared with the distance threshold. In cases in which the distance from the road to the intersection is equal to or less than the distance threshold, the distance condition can be deemed met at that particular location. As another example, a perpendicular span having the length of the distance threshold may be extended from the road. In cases which an intersection between the perpendicular span and the lane exists, the distance condition can be deemed met at that particular location.

Another example of a match condition includes a lane being within a direction threshold of a road. For instance, when a lane is within a predetermined direction relative to a road, the lane may be considered to match the road. In some cases, to identify whether a direction condition is met, a similarity of a direction of a lane at a particular location and the direction of a road at a particular location may be determined using a dot-product function, as described herein.

As such, the techniques described herein may be used to match a lane to a road, or portions thereof, and generate a lane-road mapping representing the lane-road matching. The generated lane-road mapping may be provided to an autonomous or semi-autonomous vehicle drive stack to aid in the performance in one or more operations related to localization, safe planning, and/or control of the vehicle. As such, lane-road mappings may aid an autonomous or semi-autonomous vehicle or other machine type (e.g., robot, construction vehicle, drone, etc.) in navigating a physical environment, and specifically may aid in lane inference and planning for more accurate and reliable navigation.

### BRIEF DESCRIPTION OF THE DRAWINGS

The present systems and methods for navigation-road and perception-lane matching for autonomous and semi-autonomous systems and applications are described in detail below with reference to the attached drawing figures, wherein:

FIG. 1 is a data flow diagram illustrating an example process for a lane-road matching system, in accordance with some embodiments of the present disclosure;

FIG. 2 is a data flow diagram illustrating an example process for facilitating matching lanes and roads, in accordance with some embodiments of the present disclosure;

FIG. 3 is an illustration of an example of a coverage frustum relative to vehicle position, in accordance with some embodiments of the present disclosure;

FIGS. 4A-4B provide an illustration of an effect of incorporating a prologue intersection modification, in accordance with some embodiments of the present disclosure;

FIG. 5 provides an example of generating a match score, in accordance with some embodiments of the present disclosure;

FIGS. 6-8 provides example methods for generating a lane-road mapping, in accordance with some embodiments of the present disclosure;

FIG. 9A is an illustration of an example autonomous vehicle, in accordance with some embodiments of the present disclosure;

FIG. 9B is an example of camera locations and fields of view for the example autonomous vehicle of FIG. 9A, in accordance with some embodiments of the present disclosure;

FIG. 9C is a block diagram of an example system architecture for the example autonomous vehicle of FIG. 9A, in accordance with some embodiments of the present disclosure;

FIG. 9D is a system diagram for communication between cloud-based server(s) and the example autonomous vehicle of FIG. 9A, in accordance with some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

Systems and methods are disclosed related to navigation-road and perception-lane matching for autonomous and semi-autonomous systems and applications. For example, systems and methods are disclosed that use geometric similarity to identify or detect instances of lanes matching roads, or portions thereof, for use in localization, navigation, and/or other uses by autonomous vehicles, semi-autonomous vehicles, robots, and/or other object or machine types. In this regard, the present techniques may be used to enhance the use of lane graphs. In particular, the present techniques for matching a lane to a road, or portions thereof, enable more effective lane planning and decision-making. For example, using techniques provided herein, effective lane-level instructions may be generated and used by a behavior-planning module to perform efficient and effective navigation. In addition, lanes may be annotated with road-level attributes from a road-graph, including road curvature values and traffic-control signs and signals, thereby resulting in more detailed and effective information.

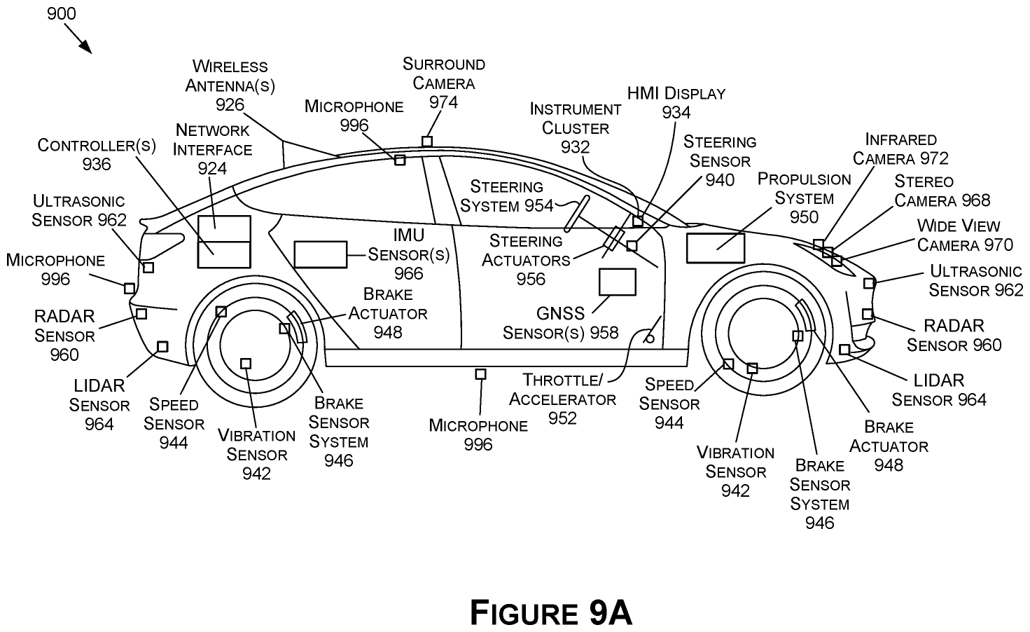

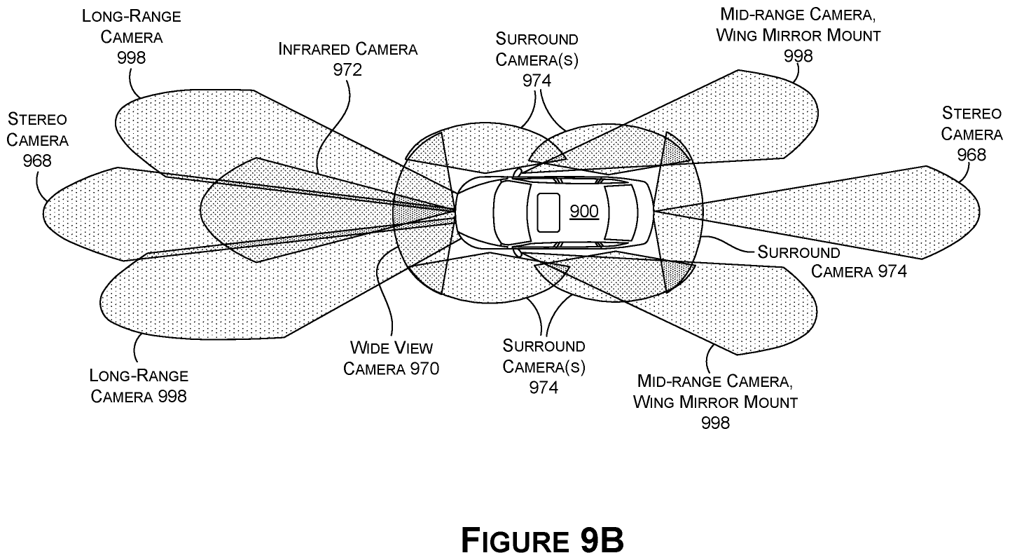

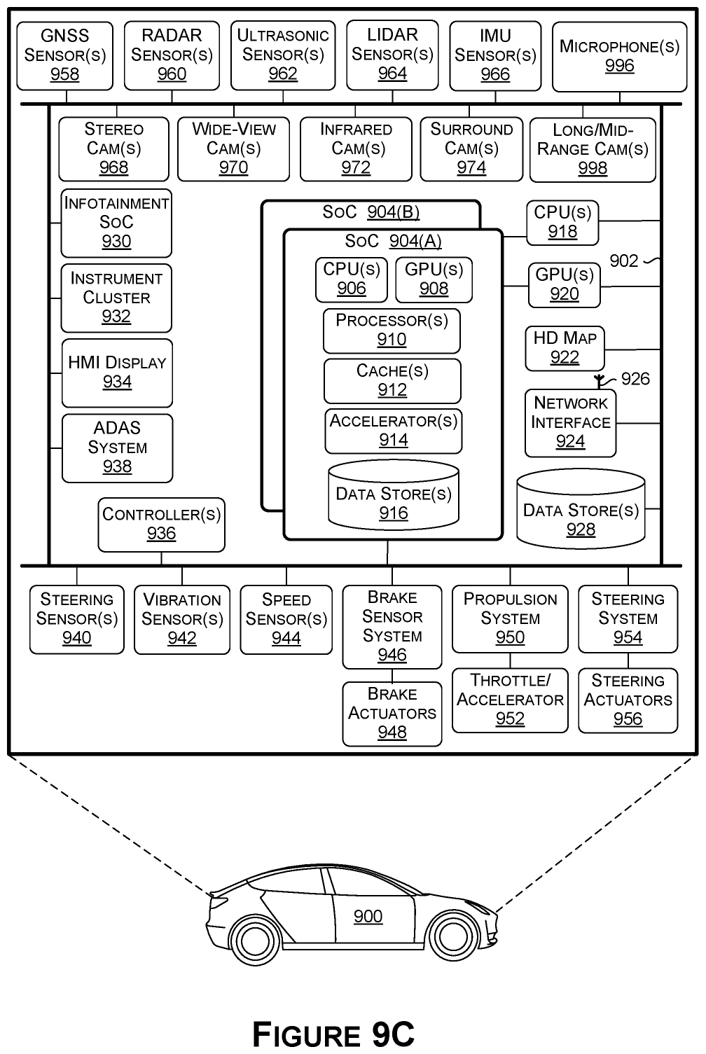

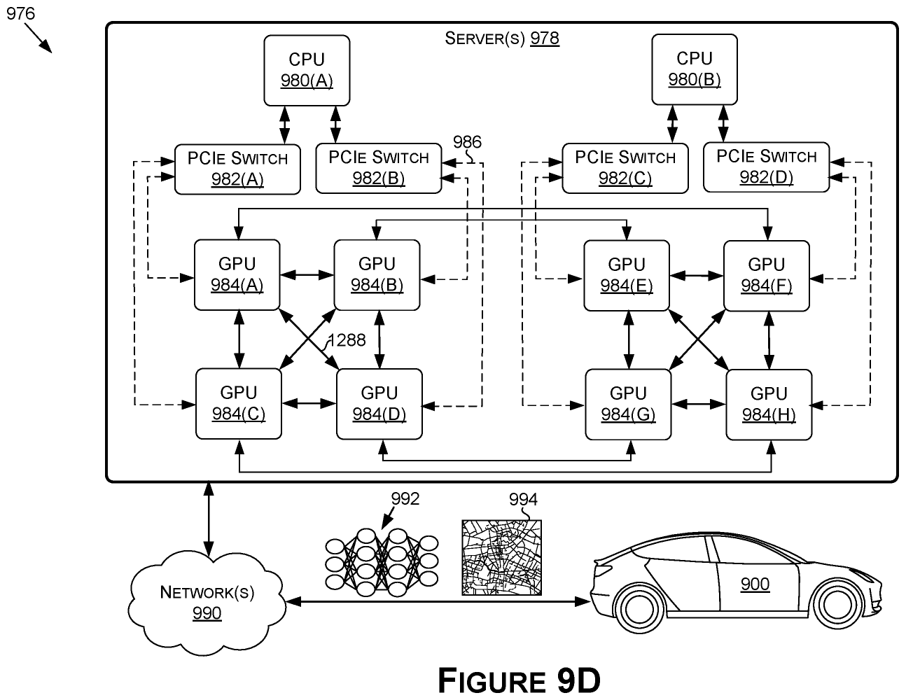

Although the present disclosure may be described with respect to an example autonomous or semi-autonomous vehicle or machine 900 (alternatively referred to herein as “vehicle 900,” “ego-vehicle 900,” “machine 900,” or “ego-machine 900,” an example of which is described with respect to FIGS. 9A-9D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to navigation-road and perception-lane matching in autonomous or semi-autonomous systems and applications, this is not intended to be limiting, and the systems and methods described herein may be used in augmented reality, virtual reality, mixed reality, robotics, security and surveillance, autonomous or semi-autonomous machine applications, and/or any other technology spaces where lane detection, localization, and/or navigation may be used.

At a high level, embodiments described herein are directed to matching a lane to a road (or another demarcated region type, such as a path, a portion of a hallway or walkway, a portion of an open space, etc. to a navigable surface), or portions thereof, and generating a lane-road mapping representing the matching. In embodiments, a lane and a road, or portions thereof, may be identified as matching based on a geometric similarity analysis. In particular, a lane may be identified as matching a road, or portions thereof, when certain match conditions specifying geometric similarity are satisfied. For example, match conditions indicating a match of a lane to a road, or portions thereof, may include the lane being within a distance threshold of the road and the lane being within a direction threshold of the road. In determining that a geometric similarity between a lane and road, or portions thereof, indicates a match, a match score may be generated to indicate an extent of such geometric similarity. As a lane may be determined to match with multiple roads (e.g., in accordance with attaining matching conditions), the match score may be used to select a particular road to map to the lane. In this way, a particular lane matching a road, or portions thereof, in association with a greatest match score may be selected for a lane-road mapping. As such, a lane-road mapping generally maps a particular lane section(s) to a road section(s) that maximizes geometric similarity (e.g., based on the match score(s)). The lane-road mapping may be represented in any number of ways. In some cases, the lane-road mapping may be represented using a lane section identifier(s) and a road section identifier(s) that correspond with a location(s) in which the lane is determined to match a road.

In operation, to identify whether a lane matches a road, or portions thereof, various points along a lane and a road may be analyzed to determine that a set of match conditions are met, indicating geometric similarity between the lane and the road. One example of a match condition includes a lane being within a distance threshold to a road. For instance, when a lane is within a predetermined distance to a road, the lane may be considered to match the road. In some cases, to identify whether a distance condition is met, a perpendicular span extending from a lane and/or a road may be analyzed (e.g., via a lane-graph and/or road-graph). For instance, a perpendicular line may be extended from a road being analyzed until it intersects with a lane being analyzed. A distance from the road to the intersection may be determined and compared with the distance threshold. In cases in which the distance from the road to the intersection is equal to or less than the distance threshold, the distance condition can be deemed met at that particular location. As another example, a perpendicular span having the length of the distance threshold may be extended from the road. In cases which an intersection between the perpendicular span and the lane exists, the distance condition can be deemed met at that particular location.

Another example of a match condition includes a lane being within a direction threshold of a road. For instance, when a lane is within a predetermined direction relative to a road, the lane may be considered to match the road. In some cases, to identify whether a direction condition is met, a similarity of a direction of a lane at a particular location and the direction of a road at a particular location may be determined using a dot-product function, as described herein.

Lane-road match analysis may be performed in association with various points or locations along a lane and/or road being analyzed. As one example, the points analyzed may be a particular distance from one another (e.g., five meters increments from one another). In embodiments, lane-road matching may be performed in an iterative manner. In this regard, analysis may progress along the length of a lane and/or road to identify whether a set of match conditions are met at the particular location. As such, at each incremental position along the road and/or lane, a set of match conditions may be analyzed in association with the lane-road pair being analyzed.

As various road sections may exist, in accordance with completing a progression in association with one road section, a determination may be made if the road has any unvisited successor road sections. In particular, any unvisited successor road sections along a current path of the traversal of the road graph may be identified. In cases in which a successor road section exists, the progression along the successor road section may continue. This iterative progression enables matching of any number of road sections.

In embodiments, the iterative process of performing match analysis for a lane and a road, or portions thereof, may continue until a termination event is identified. In this regard, the match analysis may advance along sequential points of a road and/or lane until a termination event is identified. One example of a termination event is identification of an end of a lane and/or road being analyzed. Another example of a termination event is identification of a failed match. For instance, assume a match analysis being performed in association with a particular point along a road results in failure to meet a match condition, such as a distance condition and/or direction condition. In such a case, the failure to meet a match condition may be deemed a termination event for which matching analysis may be terminated with respect to the current lane and road pair being analyzed. In some cases, matching is not terminated until a series of match condition failures are identified (e.g., in association with consecutive points along the road).

In addition to identifying a match associated with a lane and a road, or portions thereof, a match score that indicates an extent of a match may be determined. In embodiments, a match score may be based on geometric similarity. As area calculations can be computationally intensive and real-time performance in an ego-machine is desired, an approximation of area-based geometric similarity that is based around distances between the lane and the road at regularly sampled locations along the length of the road may be used. For example, given a lane and a road, a geometric similarity between a given section of lane and a given section of a road may correspond to the sum of inverses of the distances between a lane and road at sampled locations. As such, the more fitted or near the section of the lane is relative to the section of the road, the higher the geometric similarity, and therefore the higher the quality of the corresponding matching.

Based on the match scores, a lane-road map may be generated and/or provided for a particular lane-road match having a greatest match score. A lane-road mapping generally maps a lane(s) to a particular road(s), or portions thereof, that attempts to maximize or maximizes geometric similarity (e.g., based on the match score). In embodiments, a lane-road map is represented via one or more entries that indicate the matched sections. In some cases, a lane-road mapping may be represented using a lane section identifier(s) and a road section identifier(s) that correspond with locations in which the lane is determined to match the road.

As such, the techniques described herein may be used to match a lane to a road, or portions thereof, and generate a lane-road mapping representing the lane-road matching. The generated lane-road mapping may be provided to an autonomous or semi-autonomous vehicle drive stack to aid in the performance in one or more operations related to localization, safe planning, and/or control of the vehicle. As such, lane-road mappings may aid an autonomous or semi-autonomous vehicle or machine in navigating a physical environment, and specifically may aid in lane inference and planning for more accurate and reliable navigation. Unlike conventional approaches, various embodiments provide a way to enable effective lane-level instructions that may be acted upon by a behavior-planning module, thereby allowing for more precise lane selections and navigation instructions than in conventional methods. For example, embodiments enable identification of a lane that follows a road the furthest along the navigation road-graph. Further, various embodiments may be used to enable annotation of lanes with road-level attributes from the navigation road-graph, thereby enhancing lane graphs and the use thereof.

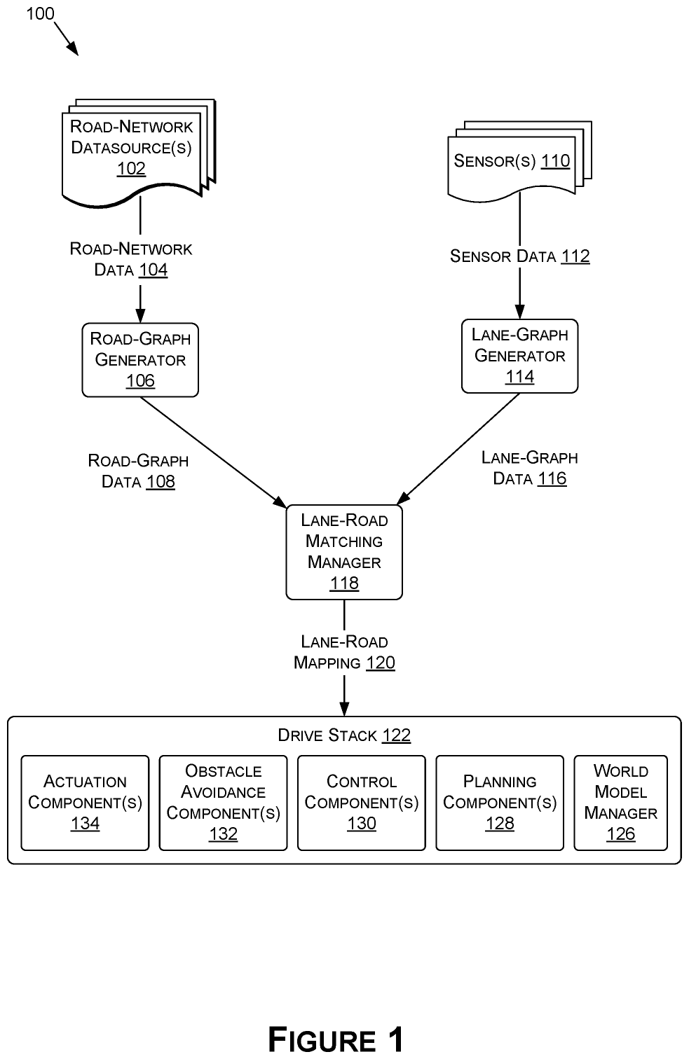

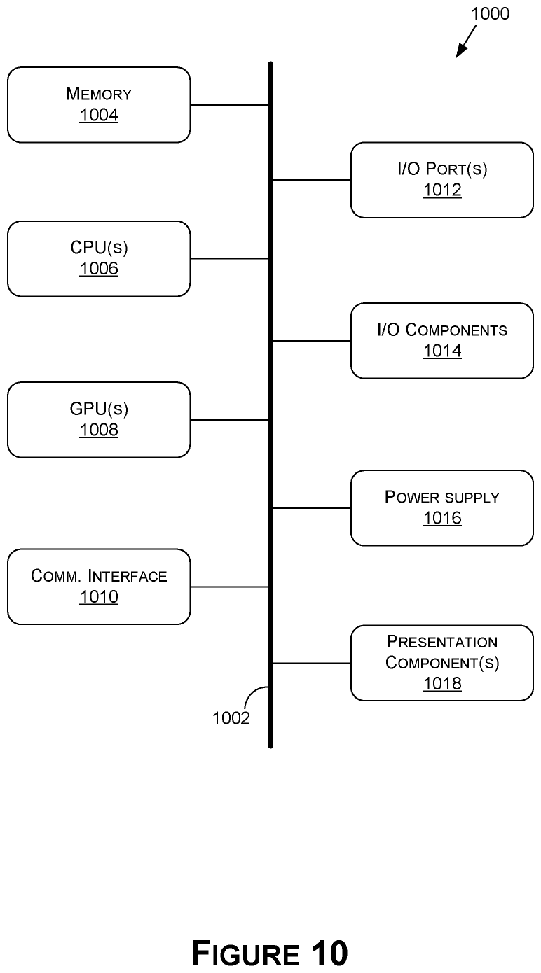

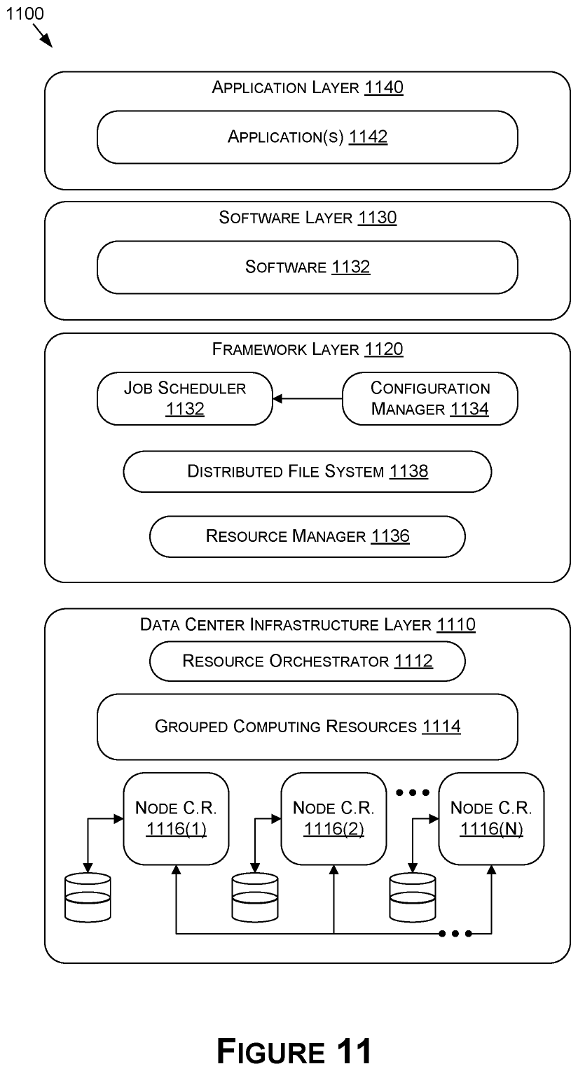

With reference to FIG. 1, FIG. 1 is a data flow diagram illustrating an example process 100 for a lane-road matching system, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 900 of FIGS. 9A-9D, example computing device 1000 of FIG. 10, and/or example data center 1100 of FIG. 11.

At a high level, the process 100 uses a lane-road matching manager 118 which may be configured to match or align a lane, or portion thereof (also may be referred to as a lane section(s)) to a road, or portion thereof (also may be referred to as a road section(s)) and generate a lane-road mapping 120. In embodiments described herein, a lane and a road, or portions thereof, may be identified as matching based on a geometric similarity analysis. In particular, a lane may be identified as matching a road, or portions thereof, when certain match conditions specifying geometric similarity are satisfied. For example, match conditions indicating a match of a lane to a road, or portions thereof, may include the lane being within a threshold distance of the road and the lane being within a threshold direction of the road. In determining that a geometric similarity between a lane and road, or portions thereof, indicates a match, a match score may be generated to indicate an extent of such geometric similarity. As a lane may be determined to match with multiple roads (e.g., in accordance with attaining matching conditions), the match score may be used to select a particular road to map to the lane. In this way, a particular lane matching a road, or portions thereof, in association with a greatest match score may be selected for a lane-road mapping. As such, a lane-road mapping generally maps a particular lane section(s) to a road section(s) that maximizes geometric similarity (e.g., based on the match score(s)). The lane-road mapping may be represented in any number of ways. In some cases, the lane-road mapping may be represented using a lane section identifier(s) and a road section identifier(s) that correspond with a location(s) in which the lane is determined to match a road.

In embodiments, the lane-road matching may be performed by lane-road matching manager 118 using road-graph data 108 and/or lane-graph data 116. In this regard, a road-graph generator 106 may generate a road-graph, and the data associated therewith may be input into the lane-road matching manager 118 to perform lane-road matching. A road-graph, or a navigation road-graph, may be a directed graph that represents a road network. Road-graph data (or road data), such as road-graph data 108, may refer to any data used to represent a road-graph (e.g., a road graph generated via road-graph generator 106). In some cases, a road-graph generator 106 resides in the vehicle. In this way, the road-graph generator 106 may generate a road-graph in real-time based on road-network data 104, for example, streamed from a road-network datasource(s) 102.

To generate a road-graph and/or road-graph data, the road-graph generator 106 may obtain and use road-network data 104. Road-network data 104 generally refers to any data representing a road network, or portion thereof. Road-network data may include, for example, information about the road network infrastructure, such as the topology and connectivity of the road network, the location of traffic signals, speed limits of different road segments, etc.

Road-network data 104 may be obtained in any manner. In some embodiments, road-network data 104 is obtained from a road-network datasource(s) 102. In some cases, the road-network datasource(s) 102 may be navigation head-unit (e.g., third-party navigation head-unit) that provides or streams road-network data encoded in a particular format, such as in accordance with ADASIS v2 specification. The ADASIS v2 specification refers to a standard for encoding road-network data in a format that may be used the road-graph generator 106.

In accordance with obtaining road-network data 104, the road-graph generator 106 may use such data to generate a road graph. As described, a road-graph may be a directed graph that represents a road network. In a road-graph, an edge in the graph may represent a section of a road that links a pair of junctions. In this regard, there may be no points of entry onto or exits off of the road section other than at the linked junctions. The direction of an edge may corresponding to the direction of travel along the road section represented by the edge. An undivided road section or a road section whose direction of travel is invertible may be represented by a pair of edges. A predecessor of a particular edge may represent a road section that continues onto the road section represented by the particular edge, and a successor of the particular edge represents a road section that the road section represented by the particular edge can continue onto.

An edge(s) of a road-graph may have an associated geometry in the form of a sequence of line segments that trace the center of the road section represented by the edge. In some cases, the sequence may be a single line segment having end-points corresponding to the end-points of the section. In other cases, the sequence may have multiple line segments that, for instance, trace changes in curvature along the length of the section. The points of line segments may be represented in any number of ways. In one embodiment, line segment points may be represented via the World Geodetic System (e.g., WGS84) coordinate space.

A road-graph may be generated for any region or area. For instance, in some cases, a road-graph is generated for a region including an immediate or near vicinity of the vehicle and along the immediate or near portion of what is deemed as a probable path or a most probable path. One example of a probable path or a most probable path includes a current section of a route that entered into a head-unit of the vehicle. Another example of a probably path or a most probable path includes a path inferred based on a historical route(s) and/or vehicle telemetry data that is interpreted to establish driver intent.

In accordance with generating a road-graph, the road-graph generator 106 may provide road-graph data 108 to the lane-road matching manager 118. As described herein, the lane-road matching component 118 may use such road-graph data to perform lane-road matching, as described herein. Alternatively or additionally, road-graph data 108 may be stored in a data store for subsequent use (e.g., by the lane-road matching manager 118).

Additionally, as described, lane-road matching may be performed by lane-road matching manager 118 using lane-graph data 116. In this regard, a lane-graph generator 114 may generate a lane-graph, and data associated therewith may be input into the lane-road matching manager 118 to perform lane-road matching. A lane-graph, or a perception lane-graph, may be a directed graph that represents a lane network. Lane-graph data (or lane data), such as lane-graph data 116, may refer to any data used to represent a lane-graph (e.g., a lane-graph generated via lane-graph generator 114).

In some cases, a lane-graph generator 114 resides in an ego-machine (e.g., autonomous vehicle). In this regard, the lane-graph generator 114 may be or include a perception component or module that generates a lane-graph in real-time based on sensor data 112, for example, streamed from a sensor(s) 110 or other component. Generally, a perception component may collect information and extract data from the environment (e.g., via a sensor(s)).

To generate a lane-graph and/or lane-graph data, the lane-graph generator 114 may obtain and use sensor data 112. In some cases, sensor data 112 may be pre-processed such that the data is in a format that may be accepted and processed. Sensor data 112 may be obtained from any number and any type of sensor(s) 110, such as, without limitation, LiDAR sensors, RADAR sensors, cameras, ultrasonic sensors, and/or other sensor types such as those described below with respect to the autonomous vehicle 900. For example, the sensor(s) 110 may include one or more sensor(s) 110 of an ego-machine—such as RADAR sensor(s) 960 of the autonomous vehicle 900 —and the sensor(s) 110 may be used to generate sensor data 112 that represents perceptions in the 3D environment in association with an ego-machine(s) as well as objects in the 3D environment around the ego-machine(s). In accordance with embodiments described herein, the sensor data 112 is collected in association with any number of ego-machines.

In accordance with obtaining sensor data 112, the lane-graph generator 114 may use such data to generate a lane-graph. As described, a lane-graph may be a directed graph that represents a lane network. In a lane-graph, an edge in the graph may represent a sequence of one or more sections of lanes of one or more linked road sections. The direction of an edge may correspond to the direction of travel along the lane sections represented by the edge, but need not be. A lane section represented by a given edge may overlap with the lane section represented by another edge. The lane of the last lane section of a predecessor of an edge represents a lane that may or may not continue onto the lane of the first lane section represent by the edge, while the lane of the last lane section of a successor of an edge represents a lane that may or may not be continued onto the lane of the first lane section represented by that edge.

An edge may have an associated geometry in the form of a sequence of line segments that trace the center of the lane section(s) represented by the edge. In some cases, the sequence may be a single line segment having end-points corresponding to the end-points of the section sequence. In other cases, the sequence may have multiple line segments that, for instance, trace changes in curvature along the length of the sections. The points of line segments may be represented in any number of ways. In one embodiment, line segment points are represented via a three-dimensional coordinate space that is local to the vehicle position and its orientation. In particular, the position of the vehicle may form the origin; the x-axis may lie along the longitudinal axis of the vehicle, where positive values are indicative of locations ahead of the vehicle; the y-axis may lie along the lateral axis of the vehicle, where positive values are indicative of locations to the left of the vehicle; and the z-axis may lie along the vertical axis of the vehicle, where positive values are indication of locations above the vehicle. In some examples, the magnitude of coordinate values may correspond to meters (or any other unit of measure). For instance, a coordinate value of (10.5, −5.3, 1.1) is interpreted as 10.5 meters ahead of the vehicle, 5.3 meters to the right of the vehicle and 1.1 meters above the vehicle.

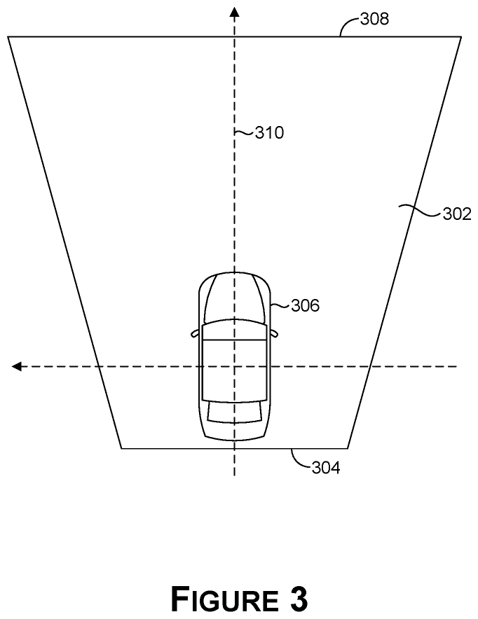

A lane-graph may be generated for any region or area. As one example, a lane-graph may correspond with a region including a frustum having a near plane behind the vehicle and a far plane ahead of the vehicle, with the vehicle location being towards the rear of the frustum and centered along the longitudinal axis of the frustum. With brief reference to FIG. 3, FIG. 3 provides an illustration of an example of a coverage frustum relative to vehicle position. In this example, the region 302 includes a near plane 304 behind the vehicle 306 and a far plane 308 in front of the vehicle. The vehicle location is towards the rear of the frustum and centered along the longitudinal axis 310 of the frustum.

In accordance with generating a lane-graph, the lane-graph generator 114 may provide lane-graph data 116 to the lane-road matching manager 118. As described herein, the lane-road matching manager 118 may use such lane-graph data to perform lane-road matching, as described herein. Alternatively or additionally, lane-graph data 116 may be stored in a data store for subsequent use (e.g., by the lane-road matching manager 118).

Upon obtaining road-graph data 108 and lane-graph data 116, the lane-road matching component 118 may perform lane-road matching. In this regard, the lane-road matching manager 118 may match or align a lane, or portion thereof (also referred to as a lane section(s)) to a road, or portion thereof (also referred to as a road section(s)). In embodiments, a lane-road matching is or includes a sequence of consecutive and contiguous sections of a given lane that match or align with a sequence of roads or road sections that form a simple path in a road-graph. A lane and a road, or portions thereof, may be identified as matching based on a geometric similarity analysis. In particular, a lane may be identified as matching a road, or portions thereof, when certain conditions are satisfied, such as the lane being within a threshold distance of the road and being within a threshold direction of the road. In determining that a lane matches a road, a match score may be generated to indicate an extent of geometric similarity. As a lane may be determined to match with multiple roads (e.g., in accordance with attaining matching conditions), the match score may be used to select a particular lane to map to the road. In this way, a particular lane matching a road in association with a greatest match score may be selected to produce a lane-road mapping 120.

A lane-road mapping, such as lane-road mapping 120, generally refers to a mapping of a lane(s) to a particular road(s), or portions thereof, that maximizes geometric similarity (e.g., based on the match score). The lane-road mapping 120 may be represented in any number of ways. In some cases, the lane-road mapping 120 may be represented using a lane section identifier(s) and a road section identifier(s) that correspond with locations in which the lane is determined to match the road. As one example, a lane-road mapping may include a sequence of entries corresponding to matching lane-road portions. An entry may include a lane section field that indicates start and end locations of a section along a lane, a road identify field that indicates the road, and a road section field that indicates the start and end locations of a section along the road.

The lane-road mapping 120 output by the lane-road matching manager 118 may be provided for use by the vehicle 900 of FIGS. 9A-9D in performing one or more operations, such as localization, navigation, and/or others. For example, a representation of the lane-road mapping 120 may be used by control component(s) of the vehicle 900, such as an autonomous or semi-autonomous driving software stack 122 executing on one or more components of the vehicle 900 of FIGS. 9A-9D (e.g., the SoC(s) 904, the CPU(s) 918, the GPU(s) 920, etc.). For example, the vehicle 900 may use this information (e.g., instances of obstacles) to localize its position in a map, navigate, plan, or otherwise perform one or more operations (e.g., obstacle or protuberance avoidance, lane keeping, lane changing, merging, splitting, adapting a suspension system of the ego-machine to match the current road surface, applying an early acceleration or deceleration based on an approaching surface slope, mapping, etc.) within the environment.

In some embodiments, the lane-road mapping 120 may be used by one or more layers of the autonomous driving software stack 122 (alternatively referred to herein as “drive stack 122”). The drive stack 122 may include a sensor manager (not shown), perception component(s) (e.g., corresponding to a perception layer of the drive stack 122), a world model manager 126, planning component(s) 128 (e.g., corresponding to a planning layer of the drive stack 122), control component(s) 130 (e.g., corresponding to a control layer of the drive stack 122), obstacle avoidance component(s) 132 (e.g., corresponding to an obstacle, or collision avoidance layer of the drive stack 122), actuation component(s) 134 (e.g., corresponding to an actuation layer of the drive stack 122), and/or other components corresponding to additional and/or alternative layers of the drive stack 122. The process 100 may, in some examples, be executed at least in part by or in association with the perception component(s), which may feed up the layers of the drive stack 122 to the world model manager, as described in more detail herein.

The sensor manager may manage and/or abstract sensor data from the sensors of the vehicle 900. For example, and with reference to FIG. 9C, the sensor data may be generated (e.g., perpetually, at intervals, based on certain conditions) by the LIDAR sensor(s) 964, the RADAR sensor(s) 960, the ultrasonic sensor(s) 962, the stereo camera(s) 968, other camera(s), and/or other sensors). The sensor manager may receive the sensor data from the sensors in different formats (e.g., sensors of the same type may output sensor data in different formats), and may be configured to convert the different formats to a uniform format (e.g., for each sensor of the same type). As a result, other components, features, and/or functionality of the autonomous vehicle 900 may use the uniform format, thereby simplifying processing of the sensor data. In some examples, the sensor manager may use a uniform format to apply control back to the sensors of the vehicle 900, such as to set frame rates or to perform gain control. The sensor manager may also update sensor packets or communications corresponding to the sensor data with timestamps to help inform processing of the sensor data by various components, features, and functionality of an autonomous vehicle control system.

A world model manager 126 may be used to generate, update, and/or define a world model. The world model manager 126 may use information generated by and received from the perception component(s) of the drive stack 122 (e.g., the locations of detected obstacles). The perception component(s) may include an obstacle perceiver, a path perceiver, a wait perceiver, a map perceiver, and/or other perception component(s). For example, the world model may be defined, at least in part, based on affordances for obstacles, paths, and wait conditions that may be perceived in real-time or near real-time by the obstacle perceiver, the path perceiver, the wait perceiver, and/or the map perceiver. The world model manager 126 may continually update the world model based on newly generated and/or received inputs (e.g., data) from the obstacle perceiver, the path perceiver, the wait perceiver, the map perceiver, and/or other components of the autonomous vehicle control system.

The world model may be used to help inform planning component(s) 128, control component(s) 130, obstacle avoidance component(s) 132, and/or actuation component(s) 134 of the drive stack 122. The obstacle perceiver may perform obstacle perception that may be based on where the vehicle 900 is allowed to drive or is capable of driving (e.g., based on the location of the drivable or other navigable paths defined by avoiding detected obstacles in the environment and/or detected protuberances in the road surface), and how fast the vehicle 900 can drive without colliding with an obstacle (e.g., an object, such as a structure, entity, vehicle, etc.) that is sensed by the sensors of the vehicle 900.

The path perceiver may perform path perception, such as by perceiving nominal paths that are available in a particular situation. In some examples, the path perceiver may further take into account lane changes for path perception. A lane graph may represent the path or paths available to the vehicle 900, and may be as simple as a single path on a highway on-ramp. In some examples, the lane graph may include paths to a desired lane and/or may indicate available changes down the highway (or other road type), or may include nearby lanes, lane changes, forks, turns, cloverleaf interchanges, merges, and/or other information. In some embodiments, the path perceiver may take into account a lane graph(s) and/or a lane-road mapping(s). For example, the path perceiver may evaluate a reconstructed 3D road surface to identify lane changes and lane merges.

The wait perceiver may be responsible to determining constraints on the vehicle 900 as a result of rules, conventions, and/or practical considerations. For example, the rules, conventions, and/or practical considerations may be in relation to a 3D road surface, traffic lights, multi-way stops, yields, merges, toll booths, gates, police or other emergency personnel, road workers, stopped buses or other vehicles, one-way bridge arbitrations, ferry entrances, etc. Thus, the wait perceiver may be leveraged to identify potential obstacles and implement one or more controls (e.g., slowing down, coming to a stop, etc.) that may not have been possible relying solely on the obstacle perceiver. In some embodiments, the wait perceiver may take into account a lane graph and/or a lane-road mapping. For example, the wait perceiver may evaluate a reconstructed 3D road surface to identify an approaching lane merge and determine to apply and/or apply an early acceleration or deceleration to accommodate the approaching lane merge.

The map perceiver may include a mechanism by which behaviors are discerned, and in some examples, to determine specific examples of what conventions are applied at a particular locale. For example, the map perceiver may determine, from data representing prior drives or trips, that at a certain intersection there are no U-turns between certain hours, that an electronic sign showing directionality of lanes changes depending on the time of day, that two traffic lights in close proximity (e.g., barely offset from one another) are associated with different roads, that in Rhode Island, the first car waiting to make a left turn at traffic light breaks the law by turning before oncoming traffic when the light turns green, and/or other information. The map perceiver may inform the vehicle 900 of static or stationary infrastructure objects and obstacles. The map perceiver may also generate information for the wait perceiver and/or the path perceiver, for example, such as to determine which light at an intersection has to be green for the vehicle 900 to take a particular path.

In some examples, information from the map perceiver may be sent, transmitted, and/or provided to server(s) (e.g., to a map manager of server(s) 978 of FIG. 9D), and information from the server(s) may be sent, transmitted, and/or provided to the map perceiver and/or a localization manager of the vehicle 900. The map manager may include a cloud mapping application that is remotely located from the vehicle 900 and accessible by the vehicle 900 over one or more network(s). For example, the map perceiver and/or the localization manager of the vehicle 900 may communicate with the map manager and/or one or more other components or features of the server(s) to inform the map perceiver and/or the localization manager of past and present drives or trips of the vehicle 900, as well as past and present drives or trips of other vehicles. The map manager may provide mapping outputs (e.g., map data) that may be localized by the localization manager based on a particular location of the vehicle 900, and the localized mapping outputs may be used by the world model manager 126 to generate and/or update the world model.

The planning component(s) 128 may include a route planner, a lane planner, a behavior planner, and a behavior selector, among other components, features, and/or functionality. The route planner may use the information from the map perceiver, the map manager, and/or the localization manager, among other information, to generate a planned path that may consist of GNSS waypoints (e.g., GPS waypoints), 3D world coordinates (e.g., Cartesian, polar, etc.) that indicate coordinates relative to an origin point on the vehicle 900, etc. The waypoints may be representative of a specific distance into the future for the vehicle 900, such as a number of city blocks, a number of kilometers, a number of feet, a number of inches, a number of miles, etc., that may be used as a target for the lane planner.

The lane planner may use a lane graph and/or lane-road mapping, object poses within the lane graph or lane-road mapping, and/or a target point and direction at the distance into the future from the route planner as inputs. The target point and direction may be mapped to the best matching drivable point and direction in the lane graph (e.g., based on GNSS and/or compass direction). A graph search algorithm may then be executed on the lane graph and/or lane-road mapping from a current edge to find the shortest path to the target point.

The behavior planner may determine the feasibility of basic behaviors of the vehicle 900, such as staying in the lane or changing lanes left or right, so that the feasible behaviors may be matched up with the most desired behaviors output from the lane planner. For example, if the desired behavior is determined to not be safe and/or available, a default behavior may be selected instead (e.g., default behavior may be to stay in lane when desired behavior or changing lanes is not safe). The behavior planner may use a lane-road mapping to facilitate such planning.

The control component(s) 130 may follow a trajectory or path (lateral and longitudinal) that has been received from the behavior selector of the planning component(s) 128 as closely as possible and within the capabilities of the vehicle 900. The control component(s) 130 may use tight feedback to handle unplanned events or behaviors that are not modeled and/or anything that causes discrepancies from the ideal (e.g., unexpected delay). In some examples, the control component(s) 130 may use a forward prediction model that takes control as an input variable, and produces predictions that may be compared with the desired state (e.g., compared with the desired lateral and longitudinal path requested by the planning component(s) 128). The control(s) that minimize discrepancy may be determined.

Although the planning component(s) 128 and the control component(s) 130 are illustrated separately, this is not intended to be limiting. For example, in some embodiments, the delineation between the planning component(s) 128 and the control component(s) 130 may not be precisely defined. As such, at least some of the components, features, and/or functionality attributed to the planning component(s) 128 may be associated with the control component(s) 130, and vice versa. This may also hold true for any of the separately illustrated components of the drive stack 122.

The obstacle avoidance component(s) 132 may aid the autonomous vehicle 900 in avoiding collisions with objects (e.g., moving and stationary objects). The obstacle avoidance component(s) 132 may include a computational mechanism at a “primal level” of obstacle avoidance, and may act as a “survival brain” or “reptile brain” for the vehicle 900. In some examples, the obstacle avoidance component(s) 132 may be used independently of components, features, and/or functionality of the vehicle 900 that is required to obey traffic rules and drive courteously. In such examples, the obstacle avoidance component(s) may ignore traffic laws, rules of the road, and courteous driving norms in order to ensure that collisions do not occur between the vehicle 900 and any objects. As such, the obstacle avoidance layer may be a separate layer from the rules of the road layer, and the obstacle avoidance layer may ensure that the vehicle 900 is only performing safe actions from an obstacle avoidance standpoint. The rules of the road layer, on the other hand, may ensure that vehicle obeys traffic laws and conventions, and observes lawful and conventional right of way (as described herein).

In some examples, the drivable or other navigable paths and/or a lane graphs(s) or lane-graph mapping(s) may be used by the obstacle avoidance component(s) 132 in determining controls or actions to take. For example, the drivable paths may provide an indication to the obstacle avoidance component(s) 132 of where the vehicle 900 may maneuver without striking any objects, protuberances, structures, and/or the like, or at least where no static structures may exist.

In non-limiting embodiments, the obstacle avoidance component(s) 132 may be implemented as a separate, discrete feature of the vehicle 900. For example, the obstacle avoidance component(s) 132 may operate separately (e.g., in parallel with, prior to, and/or after) the planning layer, the control layer, the actuation layer, and/or other layers of the drive stack 122.

As such, the vehicle 900 may use this information (e.g., as the edges, or rails of the paths) to navigate, plan, or otherwise perform one or more operations (e.g. lane keeping, lane changing, merging, splitting, etc.) within the environment. Although the drive stack 122 is illustrated as obtaining the lane-road mapping, as can be appreciated, various components associated with drive stack 122 may be used to facilitate generation of the lane-road mapping.

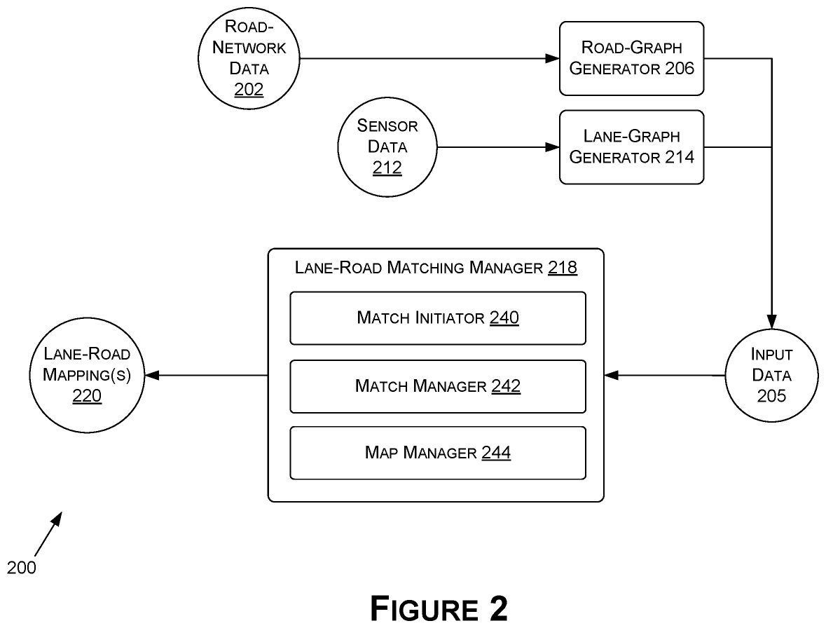

Turning now to FIG. 2, FIG. 2 is a data flow diagram illustrating an example process 200 for facilitating matching lanes and roads, in accordance with some embodiments of the present disclosure. In some embodiments, the process 200 represents a possible way for the lane-road matching manager 118 of FIG. 1 to match a lane(s) to a road(s), or portions thereof, and/or generate a lane-road mapping therefrom.

FIG. 2 illustrates a road-graph generator 206 that processes road-network data 202 and a lane-graph generator 214 that processes sensor data 212 into a format that the lane-road matching manager 218 may use (input data 205) and feeds the input data 205 into the lane-road matching manager 218, which may generate one or more lane-road mapping(s) 220. In some embodiments, the components illustrated in FIG. 2 may be implemented in an ego-machine. For example, the road-graph generator 206, the lane-graph generator 214, and the lane-road manager 218 to may operate in an ego-machine to provide, in real-time, lane-road mappings, which may be used perform localization (e.g., positioning an ego-machine in a map), path planning (e.g., determining candidate routes for an ego-machine), and/or decision making. In other embodiments, one or more of the components illustrated in FIG. 2 may be implemented remote from an ego-machine. For instance, the lane-road matching manager may operate in a server that communicates with the ego-machine.

The road-graph generator 206 is generally configured to obtain road-network data 202. The road-network data 202 may include various types of data associated with a road network. By way of example, and not limitation, road-network data may include information about the road network infrastructure, such as the topology and connectivity of the road network, the location of traffic signals, speed limits of different road segments, etc.

As described, the road-graph generator 206 generates a road-graph and data associated therewith is provided as input data 205 to the lane-road matching manager 218. The road-graph generator 206 may generate a road-graph and/or road-graph data in a streaming or real-time manner. For instance, as road-network data is streamed from a road-network datasource, the road-graph generator 206 may generate a road-graph in association with the obtained road-network data. In some cases, the road-graph data provided to the lane-road matching manager 218 may be or include the generated road-graph, or a representation thereof.

The lane-graph generator 214 is generally configured to obtain sensor data 212. The sensor data 202 may include various types of data that provides perceptions associated with an ego-machine or the environment in which the ego-machine is located.

As described, the lane-graph generator 214 generates a lane-graph and data associated therewith is provided as input data 205 to the lane-road matching manager 218. The lane-graph generator 214 may generate a lane-graph and/or lane-graph data in a streaming or real-time manner. For instance, as sensor data is streamed from one or more sensors (e.g., associated with the ego-machine or a non-ego machine), the lane-graph generator 214 may generate a lane-graph in association with the obtained sensor data. In some cases, the lane-graph data provided to the lane-road matching manager 218 may be or include the generated lane-graph, or a representation thereof.

In accordance with the lane-road matching manager 218 obtaining input data 205, including road-graph data and lane-graph data, the lane-road matching manager 218 is configured to perform lane-road matching. As illustrated, the lane-road matching manager 218 may include a match initiator 240, a match manager 242, and a map manager 244. As can be appreciated, these components are provided for illustrative purposes and any number of components may be used to implement the functionality described herein.

The match initiator 240 is generally configured to initiate performance of a lane-road matching. In this regard, the match initiator 240 may identify one or more root lanes and/or root roads to analyze for lane-road matching. In embodiments, the match initiator 240 analyzes the input data 205, such as the lane-graph data and/or road-graph data, to identify one or more root lanes and/or root roads in association therewith. A lane may be identified as a root lane when there exists a position along the geometry of the lane that is within a predetermined distance from the location of the ego-machine. In accordance with identifying a lane as a root lane, a root lane location may also be identified. A root lane location may be a position nearest the location of the ego-machine. In some cases, a same or similar position may be identified. In such a case, root lane location may be a position nearest to the beginning (or other predetermined point) of a geometry of the lane. Initiating a lane-road matching using a root lane(s) limits a lane-road matching(s) and/or lane-road mapping to a lane(s) reachable from one or more root lanes.

A road may be identified as a root road when there exists a position along the geometry of the road that is within a predetermined distance from the location of the ego-machine. In some cases, the predetermined distance is the same distance as that used to identify a root lane. In accordance with identifying a road as a root road, a root road location may also be identified. In some cases, a root road location may be a position nearest the location of the ego-machine. In instances in which multiple positions are identified as nearest the ego-machine location, a root lane location may be a position nearest to the beginning (or other predetermined point) of a geometry of the lane. Initiating a lane-road matching using root roads limits a lane-road matching(s) and/or lane-road mapping to a road(s) reachable from one or more root roads.

In embodiments, the match initiator 240 may initialize values associated with a lane-road matching. As described herein, a match score associated with a road-lane matching may be generated during the matching process. In this regard, the match initiator 240 may initialize match score values, which may be adjusted during the matching process. For instance, a match score value for a particular lane-road pair may be initialized to 0 or negative infinity. A match indicator indicating whether a lane-road pair, or portions thereof, match may also be initialized.

In some cases, the match initiator 240 may also initialize a value for a lane-road mapping. For example, for a lane-road pair, or portions thereof, a mapping may be initialized as empty, thereby indicating that no matches of a lane section(s) with a road section(s) has been identified.

In embodiments, to perform lane-road matching, the lane-graph data and/or the road-graph data may be converted or reformatted to align with one another. As one example, matching may be performed using geometric calculations corresponding with a coordinate space of the lane graph. As described, in one implementation, the lane graph may be represented or expressed in a three-dimensional coordinate space that is local to the ego-machine position and its orientation. As such, the road-graph, or data associated therewith, may be converted to this three-dimensional coordinate space. For instance, WGS84 coordinates of the points of the geometries of the roads associated with the road-graph may be transformed into coordinates that are local to the position and orientation of the ego-machine. Advantageously, in addition to eliminating a need for non-trivial spherical geometric calculations, the transformation also facilitates the lane-graph matching performance due to being relative to the vehicle position and orientation.

The match manager 242 is generally configured to perform lane-road matching. As described, lane-road matching identifies a match of a lane and a road, or portions thereof. In this regard, any number of lane sections may be identified to match any number of road sections. Identifying a lane section(s) that matches a road section(s) enables enhanced performance of various autonomous vehicle functionalities, such as lane-level instructions (e.g., used by a behavior-planning module), annotation of lanes with road-level attributes from the road-graph (e.g., road curvature values and traffic-control signs and signals), among other things.

Lane-road matching can be performed in any of a number of ways. In one embodiment, a lane is identified to match a road when a set of match conditions are met. A match condition may generally refer to any condition that may be used to identify a match between a lane and a road, or portions thereof. As described herein, lane-road matching may be performed in accordance with geometric similarity. In this way, when a lane is geometrically similar to a road, the lane-roach matching, or portions thereof, may be identified. Accordingly, a match condition may correspond with geometric similarity parameters.

One example of a match condition includes a lane being within a distance threshold to a road. For instance, when a lane is within a predetermined distance to a road, the lane may be considered to match the road. A distance threshold may be established in any number of ways. For example, the distance threshold may be based on a default setting, a preset setting, or user-selected setting. Further, a distance threshold may be represented in any number of ways. For example, a particular metric (e.g., meters) may be used to specify a distance to use a threshold for determining a match. In embodiments, a distance threshold is large enough to account for differences in the locations, orientations, and granularity between geometries of the lane-graph and road-graph, but not too large so as to degrade the plausibility of a match.

In some cases, to identify whether a distance condition is met, a perpendicular span extending from a lane and/or a road may be analyzed (e.g., via a lane-graph and/or road-graph). For instance, a perpendicular line may be extended from a road being analyzed until it intersects with a lane being analyzed. A distance from the road to the intersection, also referred to as an intersection distance, may be determined and compared with the distance threshold. In cases in which the intersection distance from the road to the intersection is equal to or less than the distance threshold, the distance condition can be deemed met at that particular location. As another example, a perpendicular span having the length of the distance threshold may be extended from the road. A perpendicular span may be of any length and/or metric. As one example, a perpendicular span may be ten meters. In cases which an intersection between the perpendicular span and the lane exists, the distance condition can be deemed met at that particular location. Although these examples extend the perpendicular span from the road to identify intersections with the lane, the perpendicular span may alternatively be extended from the lane to identify whether an intersection with a road exists and/or to identify a distance to accomplish an intersection with a road.

Another example of a match condition includes a lane being within a direction threshold direction of a road. For instance, when a lane is within a predetermined direction relative to a road, the lane may be considered to match the road. A direction threshold may be established in any number of ways. For example, the direction threshold may be based on a default setting, a preset setting, or user-selected setting. Further, a direction threshold may be represented in any number of ways. For example, a particular metric (e.g., degrees) may be used to specify a direction threshold to use for determining a match. In embodiments, a distance threshold is large enough to account for differences in the locations, orientations, and granularity between geometries of the lane-graph and road-graph, but not too large so as to degrade the plausibility of a match.

In some cases, to identify whether a direction condition is met, a similarity of a direction of a lane at a particular location and the direction of a road at a particular location may be determined using a dot-product function. Generally, when two vectors (e.g., a vector associated with a lane and a vector associated with a road) point along a same direction, the dot product is positive. The more two vectors point in the same direction, the larger the dot product resulting between the two vectors. In this way, vectors associated with points or locations in the lane and the road can be identified and used to determine whether a direction condition is met. Other methods, such as transcendental functions, may be employed for determining direction similarity.

As an example implementation using a dot-product function, the dot-product may be used to determine directionality given a road R and position r along R, a perception lane L and a position l along L. When there exists a viable perpendicular-span intersection between R and L (e.g., from r to l), a dot-product directionality test may be employed, whereby the normalized vector that represents the direction of R at r and the normalized vector that represents the direction of L at l are computed. Subsequently, the dot-product of the normalized vectors is determined, and the dot-product result is compared to a given threshold, e.g. for instance, a threshold of ˜0.77 which corresponds to about 45 degrees with respect to direction similarity.

As can be appreciated, in some cases, a direction computation for a lane and/or road (e.g., in association with a vector), may include computation of a square root, directional data, such as normalized directions, associated with geometries of lanes and/or roads may be stored (e.g., cached) for subsequent use. For example, as directions associated with a lane and/or a road may be used in future match condition analysis, on-demand caching of normalized directions may facilitate a more efficient lane-road matching process.

In some implementations, each of match condition of a set of match conditions may need to be met or attained to identify a match associated with a lane and a road, or portions thereof. For example, assume a set of match conditions includes a distance condition and a direction condition. In such a case, the distance condition and the direction condition may be required to be met to determine a lane-road match.

The match manager 242 may perform match condition analysis in association with various points or locations along a lane and/or road being analyzed. In this regard, various points or locations may be identified along a lane and/or road being analyzed and used to perform match analysis in association with those points or locations. Such points or locations may be selected in any number of ways. As one example, the points analyzed may be a particular distance from one another (e.g., five meters increments from one another). For example, assume a lane is analyzed at a first location and an intersection of a perpendicular segment extending from the lane to a road is identified at a first location. The first locations associated with the lane and the road may then be analyzed in association with one or more match conditions. Thereafter, a second location of the lane that is five meters ahead of the first location of the lane may be identified. An intersection of a perpendicular segment extending from the lane at that second position to a second location of the road may then be identified. The second locations associated with the lane and the road may then be analyzed in association with the one or more conditions.

In some cases, to identify a match between a lane and a road, or portions thereof, a threshold number of points or threshold distance of points may be analyzed and identified as matches. For instance, assume only two sequential points between a lane and a road are identified as matching. In such a case, a lane-road matching may not be determined, even though two points along the lane were identified as matching the road (e.g., meeting match conditions).

In embodiments, the match manager 242 performs lane-road matching in an iterative manner. In this regard, the match matcher 242 may progress along the length of a lane and/or road to identify whether a set of match conditions are met at the particular location. As such, at each incremental position along the road and/or lane, a set of match conditions may be analyzed in association with the lane-road pair being analyzed.

As one example, at each point in the progression along the road and/or lane, an intersection is identified between a lane and a perpendicular span of the road at a location. The perpendicular span at a location of the road may be a line segment that is centered at the location along the road and runs perpendicular to the direction of the road at the location. In some cases, the perpendicular span may extend in both directions. For example, the length of the perpendicular span may be twice the perpendicular span radius. The intersection result (e.g., between the lane and the perpendicular span extending from the road) is evaluated against a set of match conditions to establish whether or not whether a match exists. One example condition is that there exists a unique intersection location along the lane that is greater than or equal to the prior lane location. Another example match condition is that the direction of the lane at the intersection location is sufficiently similar to the direction of the road at the location in accordance to a direction similarity threshold. In cases in which a match is identified, various parameters may be updated. After identifying a match and updating any parameters, the progression along the road is advanced using an incremental amount. In some cases, the incremental amount reflects a walk rate. A higher walk rate indicates a smaller distance between successive perpendicular span locations along the length of the road-graph. A higher walk rate may result in a higher precision and plausibility of a match determination.

As described herein, various road sections may be used to represent various roads. As such, in accordance with completing a progression or walk in association with one road segment, a determination may be made if the road has any unvisited successor road segments. In particular, any unvisited successor road segments along a current path of the traversal of the road graph may be identified. In cases in which a successor road section exists, the progression along the successor road section may continue. This iterative progression enables matching of any number of road sections.

In embodiments, the iterative process of performing match analysis for a lane and a road, or portions thereof, may continue until a termination event is identified. A termination event may be any event indicating to terminate the matching analysis for the lane and/or road. In this regard, the match analysis may advance along sequential points along a road and/or lane until a termination event is identified. One example of a termination event is identification of an end of a lane and/or road being analyzed. For example, assume an end of a lane section and/or road section is identified and no subsequent or successor lane sections and/or road sections are identified. In such a case, the matching analysis may be terminated with respect to the current lane and road pair being analyzed.

Another example of a termination event is identification of a failed match. For example, assume a match analysis being performed in association with a particular point along a road results in failure to meet match condition, such as a distance condition and/or direction condition. In such a case, the failure to meet a match condition may be deemed a termination event for which matching analysis may be terminated with respect to the current lane and road pair being analyzed.

In some cases, a termination event may not be identified until a threshold number or distance of match condition failures, such as consecutive match condition failures, are identified. For instance, assume a threshold number of match condition failures is five. In such a case, upon identifying a match condition failure in association with five consecutive points along a current path of road-graph, the termination event may be identified. Implementing a threshold number or distance of match condition failures enables a more efficient process. For example, without the limit, the iterative match process can progress along the entire length of a road graph path (e.g., that runs for several hundreds of meters) without observing a viable intersection or match. In operation, the lower the limit is, the more performant the algorithm becomes, but, using a limit that is too low can result in the degradation of the plausibility of the computed matching result. Further, such an approach enables toleration of otherwise coarse-grained geometric road-presentations of standard-definition road map-data when matching them against fine-grained perception-based lane geometries (e.g., particularly at junctions having a right-angle arrangement of road-geometries, while perception lanes may capture smooth curvatures of the junction lanes).

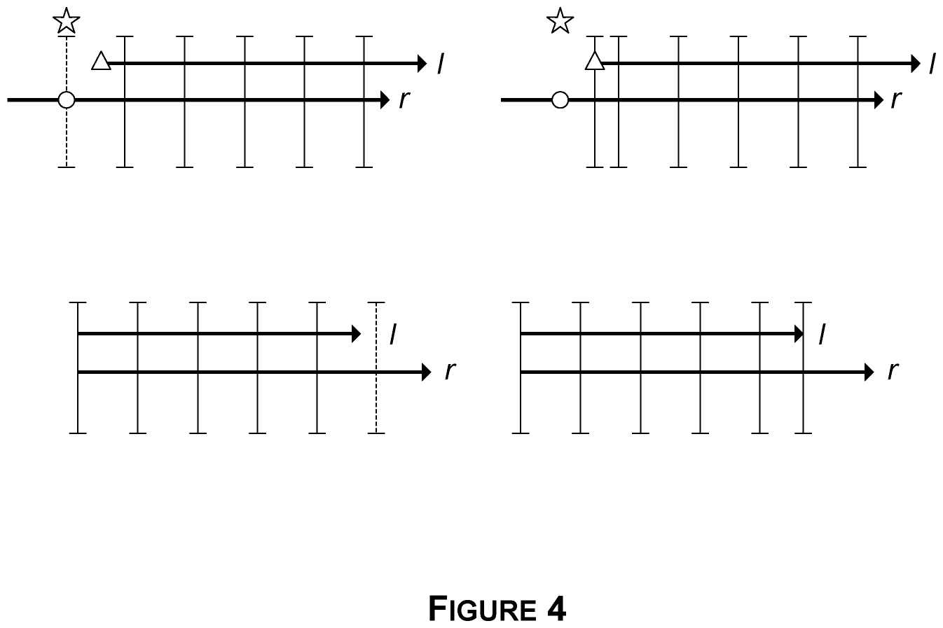

In some embodiments, the match manager 242 may be configured to perform intersection modifications in association with identifying lane-road matches. By way of example, and with reference to FIGS. 4A-4B, FIGS. 4A-4B provide an illustration of the effect of incorporating a prologue intersection modification. FIG. 4A provides an example matching computation between a root lane l and a root road r without the application of the modification, and FIG. 4B provides an example matching computation between the root lane 1 and the root road r with the application of the modification. In FIGS. 4A and 4B, the location of the ego-machine is denoted with a star, the root lane location with a triangle, and the root road location with a circle. Line segments emanating from road r denote the perpendicular spans of a threshold distance along the length of r, with dashed-line segments corresponding to non-matching results (e.g., one or more match conditions not met), and the solid-line segments corresponding to matching results (e.g., match conditions are met). In FIG. 4A, line/begins after road r along the direction of r. As a result, the initial intersection result is not viable before transitioning onto a series of viable results after the advancement of the location along r. Consequently, the computed matching between l and r exhibits a misalignment at the beginning of the match. With the addition of the prologue intersection modification, when the initial intersection result between l and r is not-viable, a fallback intersection computation is executed using an instance of the perpendicular span that is translated from the root location of r onto the root location of l, as shown in FIG. 4B. If the translated perpendicular span intersects r along a unique location and the intersection location is between the root location of r and the next location along r, the intersection result is deemed as viable, the effect of which is the elimination of the above described misalignment.

Turning not to FIGS. 4C-4D, FIGS. 4C-4D provide an illustration of the effect of incorporating the epilogue intersection modification. FIG. 4C provides an example matching computation between a terminal lane l and a road r without the application of the modification, while FIG. 4D provides an example with the application of the modification. Line segments emanating from r denote the perpendicular spans of the intersection result computations along the length of r, with dashed-line segments corresponding to non-viable matching results and solid-line segments corresponding to viable matching results. In this example, when the matching computation terminates with a sequence of non-viable results, a fall-back intersection computation may be executed using an instance of the perpendicular span of r, which is the road with the most recent viable match result, that is translated onto the end of l. If the translated perpendicular span intersects r along a unique location and the intersection location follows the most recent viable result location, i.e. along r, then it is deemed as viable, the effect of which is the elimination of the above described misalignment.

In some implementations, linear scans may be used to perform matching analysis. In other implementations, a spatial-index may be used to perform matching analysis. A spatial-index may limit the number of evaluated geometries. The spatial-index is initialized at the beginning of the Match method with the geometries of lanes that are reachable from one or more root lanes. In practice, the up-front costs associated with the construction of the spatial-index are expected to be amortized during the course of the execution of the algorithm and ultimately enable orders of magnitude reductions in the number of intersection computations performed by the algorithm.

In addition to identifying a match associated with a lane and a road, or portions thereof, the match manager 242 may be configured to generate a match score to indicate an extent of a match. In embodiments, a match score may be based on geometric similarity. As area calculations can be computationally intensive and real-time performance in an ego-machine is desired, an approximation of area-based geometric similarity that is based around distances between the lane and the road at regularly sampled locations along the length of the road may be used. For example, given a lane and a road, a geometric similarity between a given section of lane and a given section of a road may correspond to the sum of inverses of the distances between a lane and road at sampled locations. In other words, the more fitted or near the section of the lane is relative to the section of the road, the higher the geometric similarity, and therefore the higher the quality of the corresponding matching.

To determine an inverse of a distance between a location of a lane and a road, in some cases, a perpendicular span extended from the road and/or lane may be used. As one example, a perpendicular span may be extended from a road point to until the perpendicular span intersects with the lane or attains a distance threshold. Such an intersection distance may be subtracted from the distance threshold to generate an inverse of a distance between a location of a lane and a road. For instance, assume a perpendicular span is extended from a road to intersect with a lane and that such an intersection distance is identified as 0.2 units. Further assume that a distance threshold is 1.0 units. In such a case, the inverse of the distance is 1.0-0.2, resulting in a match score of 0.8 for that particular location. The relatively high match score of 0.8 indicates a high extent of similarity at that particular location.

In some cases, a match score may be determined at sampled locations (e.g., each sampled location). For instance, in accordance with progressing to a next point along a road and performing match analysis, a match score may be determined in association therewith. In some cases, the match score determined for the sampled location may be specific to that location (e.g., an inverse of the distance between the lane point and road point being analyzed). In other cases, the match score determined for the sampled location may be an aggregate or sum up to that point (e.g., a sum of inverses of the distances associated with the current sampled location and previous sampled locations along the path). Additionally or alternatively, a match score may be determined in accordance with identifying a terminal event (e.g., an end of a lane or road being analyzed). For example, as described above, when a match is no longer identified (e.g., within a threshold distance or consecutive number of points) or when an end of a lane or road is identified, a match score may be determined. In this example, when a terminal point is identified along the matching process, the match score may be determined.

The map manager 244 is generally configured to manage generation of a lane-road map. As described herein, a lane-road map provides an indication of a matching or alignment of a lane-road. In embodiments, a lane-road map is represented via one or more entries that indicate the aligned sections. A lane-road mapping, such as lane-road mapping 220, may be a mapping of a lane(s) to a particular road(s), or portions thereof, that maximizes geometric similarity (e.g., based on the match score). The lane-road mapping 220 may be represented in any number of ways. In some cases, the lane-road mapping 120 may be represented using a lane section identifier(s) and a road section identifier(s) that correspond with locations in which the lane is determined to match the road. As one example, a lane-road mapping may include a sequence of entries corresponding to matching lane-road portions. An entry may include a lane identity field that indicates a lane, a lane section field that indicates start and/or end locations of a section along a lane, a road identify field that indicates the road, and a road section field that indicates the start and/or end locations of a section along the road. As such, different entries may correspond with different lane section and road section matches. By way of example, assume a lane is identified to match a first road section. In such a case, a first entry may indicate a match between the lane and the first road section. Assume the iterative matching process continues and identifies that the lane matches a second road section that is subsequent to the first road section. In such a case, a second entry may indicate a match between the lane and the second road section.

As described, in some cases, multiple lane-road matchings may be identified. For example, a lane may be identified as matching one road path and matching another road path (e.g., based on meeting match conditions). In such a case, the map manager 244 may identify or select a best fit lane-road matching to use to generate a lane-road mapping. In this regard, the match scores may be used to select which lane-road matching to use to generate a lane-road mapping. For example, as described, a greater match score may represent a greater geometric similarity. Accordingly, to maximize geometric similarity for a lane-road mapping, a lane-road match with a greatest match score may be selected and used for generating a lane-road mapping. In other embodiments, lane-road mappings may be generated in associated with various lane-road matches and the mapping associated with a greatest match score may be selected for outputting or using in performing various autonomous vehicle functionalities, such as lane-level instructions (e.g., used by a behavior-planning module), annotation of lanes with road-level attributes from the road-graph (e.g., road curvature values and traffic-control signs and signals), among other things.

In some embodiments, the map manager 244 may perform various post-processing operations. For example, consider a lane having a match including of a section of a road r followed by a section of a road r′, where road r′ is a successor of road r. As entries of the computed matching may be based on particular locations or points of lane and road matching results, it is possible for the entry pertaining to r to define a section of r that does not end at the end of r, and, additionally, it is also possible for the entry pertaining to r′ to define a section of r′ that does not begin at the beginning of r′. Similarly, it is possible for these entries to define sections of a lane l that are not contiguous along the length of lane l. In this way, a post-processing step can be leveraged to ensure that, for instance, the mapped sections of lane l are contiguous along the length of lane l. As one example, the map manager 244 may apply heuristics to address scenarios where there is ambiguity with respect to the locations of the beginning and end of the matched sections.

By way of example only, FIG. 4 provides one illustration of lane-road matching. In FIG. 4, a lane l is analyzed for matching against a section of a road graph that includes four roads: rₐ, r_{b}, r_{c}, and r_{d}. Line segments emanating along the lengths of the road denote the perpendicular spans having a particular distance threshold. In cases in which the perpendicular span intersects with the lane, the road may be identified as a match with the lane. In FIG. 4, the solid segments indicate matches, while the dashed segments correspond to non-match results. During the course of execution, the algorithm analyzes a geometry of a lane relative to a geometry associated with paths (e.g., sequence of roads) of the road graph. In this example, a first road path includes rₐ, r_{b}, r_{d}, and a second road path includes rₐ, r_{c}. An iterative approach may be employed that progresses first along the road paths to perform geometric similarity analysis. In this way, a lane-road matching analysis may be performed at positions along the roads that correspond with the perpendicular line segments.

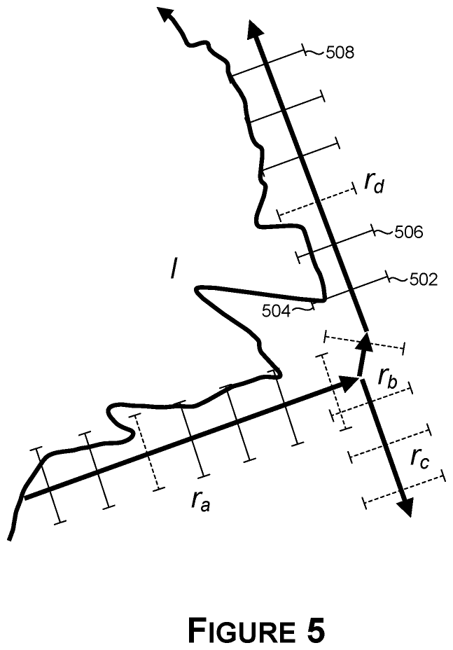

With reference to FIG. 5, FIG. 5 provides an example of generating a match score. For example, assume the first road rₐ is analyzed and results in a match score of 1. Now assume road rₐ is being analyzed for a match score. With initial reference to the line segment 502, assume the radial distance threshold to which the line segment extends 504 is 1. In some cases, the 1 threshold may represent a distance or a normalized value. Now assume it is determined that the line segment 502 intersects the lane at 0.7. In such a case, the match score may be determined to be 0.3 (1-0.7). The new aggregate match score for the path is now 1.3. Next, line segment 506 may be analyzed, resulting in a corresponding match score of 0.3 again (1-0.7). In such a case, new aggregate match score for the path is now 1.6. Assume such an iterative process continues through line segment 508, resulting in an aggregate match score of 1.6 as the remaining line segments appear to intersect at the radial distance threshold resulting in corresponding match scores of 0. In this example, as the 1.6 match score of path rₐ, r_{b}, r_{d} is greater than the 1 match score of rₐ, r_{c}, the path rₐ, r_{b}, r_{d} may be selected for producing a lane-road map.

Various example algorithms are provided below to exemplify approaches to implement the technology described herein. In these examples, a basic matching algorithm and a general matching algorithm are provided. The basic matching algorithm is generally limited to lane graphs where lanes do not have successors, while the general matching algorithm is an extension of the basic matching algorithm that eliminates the limitation of the basic matching algorithm. In this regard, the general matching algorithm may be used when lanes do have successors. As can be appreciated, the general matching algorithm is also applicable even when lanes do not have successors.

Initially, a basic match algorithm is provided that implements the basic matching algorithm:

| Match( ) | |
|---|---|
| 1. | initialize a matching and matching score for each lane |
| 2. | for each root lane l |
| 3. | initialize λ to the root location of l |
| 4. | for each root road r |
| 5. | initialize ρ to the root location of r |
| 6. | mark r as visited |
| 7. | MatchRecursive(l, λ, r, ρ, [ ], −∞) |
| 8. | mark r as not visited |

In this implementation, the method begins by initializing a mapping and an associated matching score for each lane. In this example, the mapping is initialized to empty, and the match score is initialized to negative infinity. For each root lane l and for each root road r, the method calls the basic match recursive method, which is described below. Each call to MatchRecursive results in the execution of an acyclic depth-first traversal of the road graph beginning at r. During the traversal, a mapping and a corresponding matching score are computed that are applicable to/for the sequence of roads that comprises the current path in the road graph.

At the beginning of the traversal, the computed mapping is empty while the computed matching score is equal to negative infinity. Each time the traversal reaches a terminal road, if the computed match score is greater than the match score of l, the mapping of l and match score of l are updated to the computed mapping and the computed match score, respectively.

One implementation of a basic matching algorithm for performing a recursive or iterative matching approach may be as follows:

MatchRecursive(l, λ, r, ρ, M, μ)

| | |
|---|---|
| 1. | initialize matching entry e |
| 2. | push e onto M |
| 3. | while ρ is less than length(r) |
| 4. | compute intersection of l with perpendicular span of r at ρ |
| 5. | if intersection is viable |
| 6. | update λ, e and μ |
| 7. | increment ρ in accordance to walk rate |
| 8. | if r has any unvisited successors |
| 9. | for each successor r′ of r that is unvisited |
| 10. | mark r′ as visited |
| 11. | MatchRecursive(l, λ, r′, ρ − length(r), M, μ) |
| 12. | mark r′ as not visited |
| 13. | else if μ is greater than matching score of l |
| 14. | update matching of l and matching score of l |
| 15. | pop e from M |

In this algorithm, the method includes an identity parameter, denoted by r; a road location parameter, denoted by ρ; a mapping parameter, denoted by M; and a matching score parameter, denoted by μ. The method begins by initializing a mapping sequence entry e by setting the start and end locations of the lane section field to λ, the road identity field to r, and the start and end locations of the road section field to ρ. After initialization, e is pushed onto M. Next, while ρ is less than the length of r, the method progresses along the length of r at a regular cadence referred to as the walk rate. At each step of the walk, an intersection result is computed between l and the perpendicular span of r at location ρ. The perpendicular span of r at location ρ may be a line segment that is centered at location ρ along r and runs perpendicular to the direction of r at location ρ. The length of the perpendicular span may be twice the perpendicular span radius. The intersection result may be evaluated against a pair of conditions to establish whether or not it represents a match.

In this example, the first condition is that there exists a unique intersection location along/that is greater-than or equal-to λ. The second condition is that the direction of l at the intersection location is sufficiently similar to the direction of r at location ρ in accordance to a direction similarity threshold. If the intersection result is identified as a match, then it is processed. A match result may be processed by λ being set to the intersection location along l; the end location of the lane section field of e being set to the intersection location along l; the end location of the road section field of e being set to ρ; and μ being incremented by the difference between the perpendicular span radius and the distance between the intersection location along l and the location ρ along r. After the computation of the match result and, if applicable, its processing, the walk along r is advanced by p being incremented by an amount that reflects the walk rate. Upon finishing the walk, if r has any unvisited successors, e.g., along the current path of the traversal of the road graph, the method calls itself recursively for each successor r′ of r that is yet to be visited, using l for the lane identity parameter, λ for the lane location parameter, r′ for the road identity parameter, ρ—length (r) for the road location parameter, M for the mapping sequence parameter, and μ for the match sequence score parameter. If r does not have any unvisited successors, then the method processes the computed matching result by examining μ and the matching score of l. If μ is greater than the matching score of l, then the matching of l is updated to M while the matching score of l is updated to μ. At the end of the method, e is popped from M.

Turning to the general matching algorithm, the below example provides a match method that implements the general matching algorithm:

| Match( ) | |
|---|---|
| 1. | initialize a matching and matching score for each lane |
| 2. | for each root lane l |
| 3. | initialize λ to the root location of l |
| 4. | mark l as visited |
| 5. | for each root road r |
| 6. | initialize ρ to the root location of r |
| 7. | mark r as visited |
| 8. | MatchRecursive(l, λ, r, ρ, [ ], −∞) |
| 9. | mark r as not visited |
| 10. | mark l as not visited |

This approach is generally similar to the match method of the basic matching algorithm. In this approach, a version of the general match recursive method is called that results in the execution of an acyclic depth-first traversal of the road graph beginning at r and an acyclic depth-first traversal of the lane graph beginning at l. During the traversal, a mapping and a corresponding matching score may be computed that are applicable to the lanes in the sequence of lanes that comprises the current path in the lane graph for the sequence of roads that comprises the current path in the road graph. Each time the traversal reaches a terminal road, for each lane l in the current path in the lane, if the computed match score is greater than the match score of l, then the mapping of l is updated to sub-sequence of entries in the computed mapping that are specific to l, while the match score of l is updated to the computed match score.

One example of the general matching algorithm for performing a recursive or iterative matching approach is provided as follows:

MatchRecursive(l, λ, r, ρ, M, μ)

| | |
|---|---|
| 1. | initialize matching entry e |
| 2. | push e onto M |
| 3. | while ρ is less than length(r) |
| 4. | compute intersection of l with perpendicular span of r at ρ |
| 5. | if intersection is viable |
| 6. | update λ, e and μ |
| 7. | else if l has any unvisited successors |
| 8. | for each successor l′ of l that is not visited |
| 9. | mark l′ as visited |
| 10. | MatchRecursive(l′, 0, r, ρ, M, μ) |
| 11. | mark l′ as not visited |
| 12. | increment ρ by a fixed distance |
| 13. | if r has any unvisited successors |
| 14. | for each successor r′ of r that is unvisited |
| 15. | mark r′ as visited |
| 16. | MatchRecursive(l, λ, r′, ρ − length(r), M, μ) |
| 17. | mark r′ as not visited |
| 18. | else |
| 19. | for each sub-sequence of entries for a given lane l′ in current matching sequence |
| 20. | if ρ is greater than matching score of l′ |
| 21. | update matching of l′ and matching score of l′ |
| 22. | pop e from M |

This approach is generally similar to the corresponding approach of the basic matching algorithm. In this approach, entries of the current mapping may be extended with the addition of a lane identity field. The lane identity field indicates that the entry is specific to a given lane. At the beginning of the method, when e is initialized, the lane identity field of e may be set to l. Upon finishing the walk of r, when r does not have any unvisited successors, the method processes the computed mapping result by examining the match score of each lane l′ for which there exists one or more entries in the computed matching whose lane field is l′. For each such lane l′, if μ is greater than the matching score of l′, then the matching of l′ is updated to the sub sequence of entries in the computed matching whose lane field is equal to l′, while the matching score of l′ is updated to μ.

Further, in this approach, when the computed intersection result is not identified as a match, the method proceeds to call MatchRecursive recursively for each lane that is an unvisited successor of l. In other words, if a matching intersection result does not exist at the current lane, the method moves onto attempting to generate matching intersections with lanes in the unvisited sub-paths of the lane graph rooted at the lane.

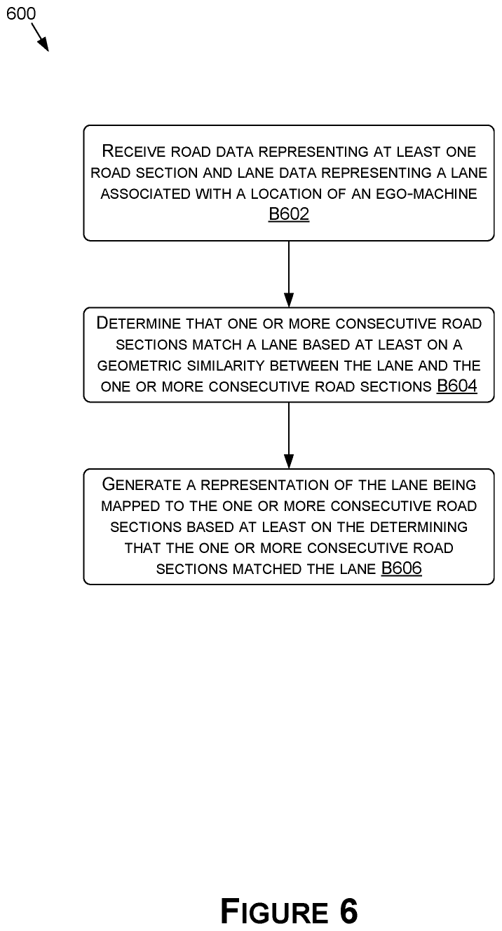

Now referring to FIGS. 6-8, each block of methods 600, 700, and 800, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, the methods 600, 700, and 800 may be described, by way of example, with respect to the lane-road matching system of FIG. 1. However, these methods may additionally or alternatively be executed by any one system, or any combination of systems, including, but not limited to, those described herein.

FIG. 6 is a flow diagram showing a method 600 for generating a lane-road mapping, in accordance with some embodiments of the present disclosure. The method 600, at block B602, includes receiving road data representing at least one road section and lane data representing a lane associated with a location of an ego-machine. The road data representing the road section(s) may be road-graph data, and the lane data representing the lane may be lane-graph data.

The method 600, at block B604, includes determining that one or more consecutive road sections match a lane based at least on a geometric similarity between the lane and the one or more consecutive road sections. Determining a road section(s) matches a lane based on a geographic similarity may be performed in any number of ways. As one example, such a determination may be based on the lane being positioned within a distance threshold of one or more points along the consecutive road section(s). In some cases, determining whether the lane is positioned within a distance threshold may include extending perpendicular line segments from a point(s) along the consecutive road section(s) to intersect with the lane. Such a determination may be performed in an iterative manner, for example, by progressing along consecutive points (e.g., positioned a predetermined distance apart) of the consecutive road section(s). Alternatively or additionally, such a determination may be based on the lane being positioned within a direction threshold of one or more points along the consecutive road section(s). In some embodiments, an extent to which the consecutive road section(s) matches the lane is determined. In some cases, such an extent may be generated based on a sum of one or more inverses of distances between the lane and one or more sampled locations along the consecutive road section(s).

The method 600, at block B606, includes generating a representation of the lane being mapped to the one or more consecutive road sections based at least on the determining that the one or more consecutive road sections matched the lane. In some embodiments, a representation of the lane being mapped to the consecutive road section(s) may be based on a determination to generate the mapping. For example, a mapping may be desired when the extent to which the consecutive road section(s) matches the lane is greater than other matching extents associated with other road sections. In one embodiment, the representation of the lane mapped to the consecutive road section(s) includes a representation of a start and end location of a section along the lane, a representation of an identity of at least a portion of the consecutive road sections, and a representation of a start and end location of at least one road section.

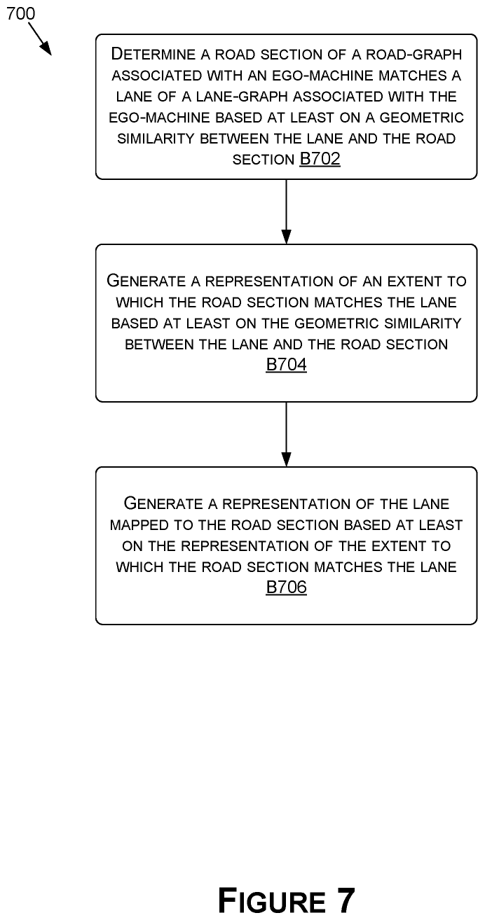

FIG. 7 is a flow diagram showing a method 700 for generating a lane-road mapping, in accordance with some embodiments of the present disclosure. The method 700, at block B702, includes determining that a road section of a road-graph associated with an ego-machine matches a lane of a lane-graph associated with the ego-machine based at least on a geometric similarity between the lane and the road section. Determining a road section(s) matches a lane based on a geographic similarity may be performed in any number of ways. As one example, such a determination may be based on the lane being positioned within a distance threshold of one or more points along the consecutive road section(s). In some cases, determining whether the lane is positioned within a distance threshold may include extending perpendicular line segments from a point(s) along the consecutive road section(s) to intersect with the lane. Alternatively or additionally, such a determination may be based on the lane being positioned within a direction threshold of one or more points along the consecutive road section(s). In one embodiment, a matching determination may be performed in an iterative manner, for example, by progressing along consecutive points (e.g., positioned a predetermined distance apart) of the consecutive road section(s) until a termination event is detected. For example, a termination event may be detected when a road or lane ends. As another example, a termination event may be detected when a threshold number (e.g., five) match failures are consecutively identified along points of the road.

The method 700, at block B704, includes generating a representation of an extent to which the road section matches the lane based at least on the geometric similarity between the lane and the road section. In one embodiment, the representation of the extent to which the road section matches the lane is generated based at least on a sum of one or more inverses of one or more distances between the lane and one or more sampled locations along the road section.

The method 700, at block B706, includes generating a representation of the lane mapped to the road section based at least on the representation of the extent to which the road section matches the lane. In some embodiments, a representation of the lane being mapped to the consecutive road section(s) may be based on a determination to generate the mapping. For example, a mapping may be desired when the extent to which the consecutive road section(s) matches the lane is greater than other matching extents associated with other road sections. In one embodiment, the representation of the lane mapped to the consecutive road section(s) includes a representation of a start and end location of a section along the lane, a representation of an identity of at least a portion of the consecutive road sections, and a representation of a start and end location of at least one road section.

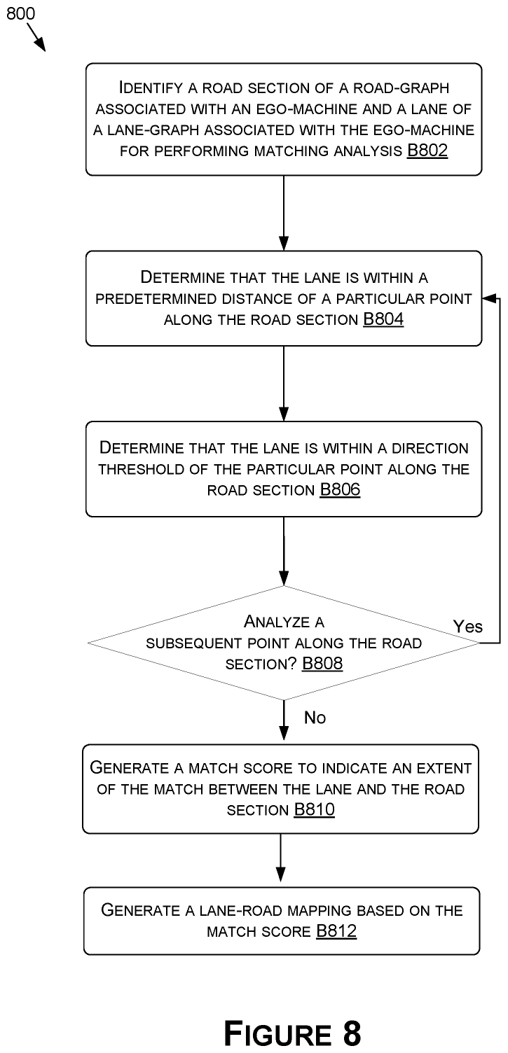

FIG. 8 is a flow diagram showing a method 800 for generating a lane-road mapping, in accordance with some embodiments of the present disclosure. The method 800, at block B802, includes identifying a road section of a road-graph associated with an ego-machine and a lane of a lane-graph associated with the ego-machine for performing matching analysis. In some cases, the road section and the lane are identified based on proximity to the ego-machine.

The method 800, at block B804, includes determining that the lane is within a predetermined distance of a particular point along the road section. In some cases, to identify whether a distance condition is met, a perpendicular span extending from the lane and/or road section may be analyzed. For instance, a perpendicular line may be extended from the road section being analyzed until it intersects with the lane being analyzed. A distance from the road to the intersection may be determined and compared with the predetermined distance. As another example, a perpendicular span having the length of the distance threshold may be extended from the road. A perpendicular span may be of any length and/or metric. As one example, a perpendicular span may be ten meters. In cases which an intersection between the perpendicular span and the lane exists, the distance condition can be deemed met at that particular location.

The method 800, at block B806, includes determining that the lane is within a direction threshold of the particular point along the road section. A direction threshold may be established in any number of ways. For example, the direction threshold may be based on a default setting, a preset setting, or user-selected setting. Further, a direction threshold may be represented in any number of ways. For example, a particular metric (e.g., degrees) may be used to specify a direction threshold to use for determining a match. In some cases, to identify whether a direction condition is met, a similarity of a direction of a lane at a particular location and the direction of a road at a particular location may be determined using a dot-product function.

The method 800, at block B808, includes determining whether to analyze a subsequent point along the road section. For example, when a termination event is identified, a determination may be made to end analysis of subsequent points along the road section. A termination event may be identification of an end of a lane and/or road. Another example of a termination event may be a failure to meet a match condition or a failure to meet a match condition in association with a predetermined number of consecutive points (e.g., five consecutive match failures). In cases which another subsequent point along the road section may be analyzed, the method returns to block B804 and B806 to assess match conditions for the next point.

On the other hand, when it is determine no further subsequent points along the road section are to be analyzed, the method 800 proceeds to block B810, at which a match score is generated to indicate an extent of the match between the lane and the road section. The match score may be based on geometric similarity. For example, given a lane and a road, a geometric similarity between a given section of lane and a given section of a road may correspond to the sum of inverses of the distances between a lane and road at sampled locations. To determine an inverse of a distance between a location of a lane and a road, in some cases, a perpendicular span extended from the road and/or lane may be used. As one example, a perpendicular span may be extended from a road point to until the perpendicular span intersects with the lane or attains a distance threshold. Such an intersection distance may be subtracted from the distance threshold to generate an inverse of a distance between a location of a lane and a road.

The method 800, at block B812, generate a lane-road mapping based on the match score. For example, in some cases, a lane-road mapping may be generated when the match score is greater than other match scores associated with other lane-road section pairs.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Autonomous Vehicle

FIG. 9A is an illustration of an example autonomous vehicle 900, in accordance with some embodiments of the present disclosure. The autonomous vehicle 900 (alternatively referred to herein as the “vehicle 900”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 900 may be capable of functionality in accordance with one or more of Level 3-Level 5 of the autonomous driving levels. The vehicle 900 may be capable of functionality in accordance with one or more of Level 1-Level 5 of the autonomous driving levels. For example, the vehicle 900 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 900 or other machine, such as being fully autonomous, being highly autonomous, being conditionally autonomous, being partially autonomous, providing assistive autonomy, being semi-autonomous, being primarily autonomous, or other designation.

The vehicle 900 may include components such as a chassis, a vehicle body, wheels (e.g., 2, 4, 6, 8, 18, etc.), tires, axles, and other components of a vehicle. The vehicle 900 may include a propulsion system 950, such as an internal combustion engine, hybrid electric power plant, an all-electric engine, and/or another propulsion system type. The propulsion system 950 may be connected to a drive train of the vehicle 900, which may include a transmission, to enable the propulsion of the vehicle 900. The propulsion system 950 may be controlled in response to receiving signals from the throttle/accelerator 952.

A steering system 954, which may include a steering wheel, may be used to steer the vehicle 900 (e.g., along a desired path or route) when the propulsion system 950 is operating (e.g., when the vehicle is in motion). The steering system 954 may receive signals from a steering actuator 956. The steering wheel may be optional for full automation (Level 5) functionality.

The brake sensor system 946 may be used to operate the vehicle brakes in response to receiving signals from the brake actuators 948 and/or brake sensors.

Controller(s) 936, which may include one or more system on chips (SoCs) 904 (FIG. 9C) and/or GPU(s), may provide signals (e.g., representative of commands) to one or more components and/or systems of the vehicle 900. For example, the controller(s) may send signals to operate the vehicle brakes via one or more brake actuators 948, to operate the steering system 954 via one or more steering actuators 956, to operate the propulsion system 950 via one or more throttle/accelerators 952. The controller(s) 936 may include one or more onboard (e.g., integrated) computing devices (e.g., supercomputers) that process sensor signals, and output operation commands (e.g., signals representing commands) to enable autonomous driving and/or to assist a human driver in driving the vehicle 900. The controller(s) 936 may include a first controller 936 for autonomous driving functions, a second controller 936 for functional safety functions, a third controller 936 for artificial intelligence functionality (e.g., computer vision), a fourth controller 936 for infotainment functionality, a fifth controller 936 for redundancy in emergency conditions, and/or other controllers. In some examples, a single controller 936 may handle two or more of the above functionalities, two or more controllers 936 may handle a single functionality, and/or any combination thereof.

The controller(s) 936 may provide the signals for controlling one or more components and/or systems of the vehicle 900 in response to sensor data received from one or more sensors (e.g., sensor inputs). The sensor data may be received from, for example and without limitation, global navigation satellite systems (“GNSS”) sensor(s) 958 (e.g., Global Positioning System sensor(s)), RADAR sensor(s) 960, ultrasonic sensor(s) 962, LIDAR sensor(s) 964, inertial measurement unit (IMU) sensor(s) 966 (e.g., accelerometer(s), gyroscope(s), magnetic compass(es), magnetometer(s), etc.), microphone(s) 996, stereo camera(s) 968, wide-view camera(s) 970 (e.g., fisheye cameras), infrared camera(s) 972, surround camera(s) 974 (e.g., 360 degree cameras), long-range and/or mid-range camera(s) 998, speed sensor(s) 944 (e.g., for measuring the speed of the vehicle 900), vibration sensor(s) 942, steering sensor(s) 940, brake sensor(s) (e.g., as part of the brake sensor system 946), and/or other sensor types.

One or more of the controller(s) 936 may receive inputs (e.g., represented by input data) from an instrument cluster 932 of the vehicle 900 and provide outputs (e.g., represented by output data, display data, etc.) via a human-machine interface (HMI) display 934, an audible annunciator, a loudspeaker, and/or via other components of the vehicle 900. The outputs may include information such as vehicle velocity, speed, time, map data (e.g., the High Definition (“HD”) map 922 of FIG. 9C), location data (e.g., the vehicle's 900 location, such as on a map), direction, location of other vehicles (e.g., an occupancy grid), information about objects and status of objects as perceived by the controller(s) 936, etc. For example, the HMI display 934 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 900 further includes a network interface 922 which may use one or more wireless antenna(s) 926 and/or modem(s) to communicate over one or more networks. For example, the network interface 922 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 926 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 9B is an example of camera locations and fields of view for the example autonomous vehicle 900 of FIG. 9A, in accordance with some embodiments of the present disclosure. The cameras and respective fields of view are one example embodiment and are not intended to be limiting. For example, additional and/or alternative cameras may be included and/or the cameras may be located at different locations on the vehicle 900.

The camera types for the cameras may include, but are not limited to, digital cameras that may be adapted for use with the components and/or systems of the vehicle 900. The camera(s) may operate at automotive safety integrity level (ASIL) B and/or at another ASIL. The camera types may be capable of any image capture rate, such as 60 frames per second (fps), 190 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (3D printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 900 (e.g., front-facing cameras) may be used for surround view, to help identify forward facing paths and obstacles, as well aid in, with the help of one or more controllers 936 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 970 that may be used to perceive objects coming into view from the periphery (e.g., pedestrians, crossing traffic or bicycles). Although only one wide-view camera is illustrated in FIG. 9B, there may be any number (including zero) of wide-view cameras 970 on the vehicle 900. In addition, any number of long-range camera(s) 998 (e.g., a long-view stereo camera pair) may be used for depth-based object detection, especially for objects for which a neural network has not yet been trained. The long-range camera(s) 998 may also be used for object detection and classification, as well as basic object tracking.

Any number of stereo cameras 968 may also be included in a front-facing configuration. In at least one embodiment, one or more of stereo camera(s) 968 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 968 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 968 may be used in addition to, or alternatively from, those described herein.

Cameras with a field of view that include portions of the environment to the side of the vehicle 900 (e.g., side-view cameras) may be used for surround view, providing information used to create and update the occupancy grid, as well as to generate side impact collision warnings. For example, surround camera(s) 974 (e.g., four surround cameras 974 as illustrated in FIG. 9B) may be positioned to on the vehicle 900. The surround camera(s) 974 may include wide-view camera(s) 970, fisheye camera(s), 360 degree camera(s), and/or the like. Four example, four fisheye cameras may be positioned on the vehicle's front, rear, and sides. In an alternative arrangement, the vehicle may use three surround camera(s) 974 (e.g., left, right, and rear), and may leverage one or more other camera(s) (e.g., a forward-facing camera) as a fourth surround view camera.

Cameras with a field of view that include portions of the environment to the rear of the vehicle 900 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 998, stereo camera(s) 968), infrared camera(s) 972, etc.), as described herein.

FIG. 9C is a block diagram of an example system architecture for the example autonomous vehicle 900 of FIG. 9A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 900 in FIG. 9C are illustrated as being connected via bus 902. The bus 902 may include a Controller Area Network (CAN) data interface (alternatively referred to herein as a “CAN bus”). A CAN may be a network inside the vehicle 900 used to aid in control of various features and functionality of the vehicle 900, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 902 is described herein as being a CAN bus, this is not intended to be limiting. For example, in addition to, or alternatively from, the CAN bus, FlexRay and/or Ethernet may be used. Additionally, although a single line is used to represent the bus 902, this is not intended to be limiting. For example, there may be any number of busses 902, which may include one or more CAN busses, one or more FlexRay busses, one or more Ethernet busses, and/or one or more other types of busses using a different protocol. In some examples, two or more busses 902 may be used to perform different functions, and/or may be used for redundancy. For example, a first bus 902 may be used for collision avoidance functionality and a second bus 902 may be used for actuation control. In any example, each bus 902 may communicate with any of the components of the vehicle 900, and two or more busses 902 may communicate with the same components. In some examples, each SoC 904, each controller 936, and/or each computer within the vehicle may have access to the same input data (e.g., inputs from sensors of the vehicle 900), and may be connected to a common bus, such the CAN bus.

The vehicle 900 may include one or more controller(s) 936, such as those described herein with respect to FIG. 9A. The controller(s) 936 may be used for a variety of functions. The controller(s) 936 may be coupled to any of the various other components and systems of the vehicle 900, and may be used for control of the vehicle 900, artificial intelligence of the vehicle 900, infotainment for the vehicle 900, and/or the like.

The vehicle 900 may include a system(s) on a chip (SoC) 904. The SoC 904 may include CPU(s) 906, GPU(s) 908, processor(s) 910, cache(s) 912, accelerator(s) 914, data store(s) 916, and/or other components and features not illustrated. The SoC(s) 904 may be used to control the vehicle 900 in a variety of platforms and systems. For example, the SoC(s) 904 may be combined in a system (e.g., the system of the vehicle 900) with an HD map 922 which may obtain map refreshes and/or updates via a network interface 922 from one or more servers (e.g., server(s) 978 of FIG. 9D).

The CPU(s) 906 may include a CPU cluster or CPU complex (alternatively referred to herein as a “CCPLEX”). The CPU(s) 906 may include multiple cores and/or L2 caches. For example, in some embodiments, the CPU(s) 906 may include eight cores in a coherent multi-processor configuration. In some embodiments, the CPU(s) 906 may include four dual-core clusters where each cluster has a dedicated L2 cache (e.g., a 2 MB L2 cache). The CPU(s) 906 (e.g., the CCPLEX) may be configured to support simultaneous cluster operation enabling any combination of the clusters of the CPU(s) 906 to be active at any given time.

The CPU(s) 906 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 906 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 908 may include an integrated GPU (alternatively referred to herein as an “iGPU”). The GPU(s) 908 may be programmable and may be efficient for parallel workloads. The GPU(s) 908, in some examples, may use an enhanced tensor instruction set. The GPU(s) 908 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 908 may include at least eight streaming microprocessors. The GPU(s) 908 may use compute application programming interface(s) (API(s)). In addition, the GPU(s) 908 may use one or more parallel computing platforms and/or programming models (e.g., NVIDIA's CUDA).

The GPU(s) 908 may be power-optimized for best performance in automotive and embedded use cases. For example, the GPU(s) 908 may be fabricated on a Fin field-effect transistor (FinFET). However, this is not intended to be limiting and the GPU(s) 908 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 908 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 908 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 908 to access the CPU(s) 906 page tables directly. In such examples, when the GPU(s) 908 memory management unit (MMU) experiences a miss, an address translation request may be transmitted to the CPU(s) 906. In response, the CPU(s) 906 may look in its page tables for the virtual-to-physical mapping for the address and transmits the translation back to the GPU(s) 908. As such, unified memory technology may allow a single unified virtual address space for memory of both the CPU(s) 906 and the GPU(s) 908, thereby simplifying the GPU(s) 908 programming and porting of applications to the GPU(s) 908.

In addition, the GPU(s) 908 may include an access counter that may keep track of the frequency of access of the GPU(s) 908 to memory of other processors. The access counter may help ensure that memory pages are moved to the physical memory of the processor that is accessing the pages most frequently.

The SoC(s) 904 may include any number of cache(s) 912, including those described herein. For example, the cache(s) 912 may include an L3 cache that is available to both the CPU(s) 906 and the GPU(s) 908 (e.g., that is connected both the CPU(s) 906 and the GPU(s) 908). The cache(s) 912 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 904 may include an arithmetic logic unit(s) (ALU(s)) which may be leveraged in performing processing with respect to any of the variety of tasks or operations of the vehicle 900—such as processing DNNs. In addition, the SoC(s) 904 may include a floating point unit(s) (FPU(s))—or other math coprocessor or numeric coprocessor types—for performing mathematical operations within the system. For example, the SoC(s) 904 may include one or more FPUs integrated as execution units within a CPU(s) 906 and/or GPU(s) 908.

The SoC(s) 904 may include one or more accelerators 914 (e.g., hardware accelerators, software accelerators, or a combination thereof). For example, the SoC(s) 904 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 908 and to off-load some of the tasks of the GPU(s) 908 (e.g., to free up more cycles of the GPU(s) 908 for performing other tasks). As an example, the accelerator(s) 914 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 914 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 908, and by using an inference accelerator, for example, a designer may target either the DLA(s) or the GPU(s) 908 for any function. For example, the designer may focus processing of CNNs and floating point operations on the DLA(s) and leave other functions to the GPU(s) 908 and/or other accelerator(s) 914.

The accelerator(s) 914 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 906. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 914 (e.g., the hardware acceleration cluster) may include a computer vision network on-chip and SRAM, for providing a high-bandwidth, low latency SRAM for the accelerator(s) 914. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 904 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 914 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 966 output that correlates with the vehicle 900 orientation, distance, 3D location estimates of the object obtained from the neural network and/or other sensors (e.g., LIDAR sensor(s) 964 or RADAR sensor(s) 960), among others.

The SoC(s) 904 may include data store(s) 916 (e.g., memory). The data store(s) 916 may be on-chip memory of the SoC(s) 904, which may store neural networks to be executed on the GPU and/or the DLA. In some examples, the data store(s) 916 may be large enough in capacity to store multiple instances of neural networks for redundancy and safety. The data store(s) 912 may comprise L2 or L3 cache(s) 912. Reference to the data store(s) 916 may include reference to the memory associated with the PVA, DLA, and/or other accelerator(s) 914, as described herein.

The SoC(s) 904 may include one or more processor(s) 910 (e.g., embedded processors). The processor(s) 910 may include a boot and power management processor that may be a dedicated processor and subsystem to handle boot power and management functions and related security enforcement. The boot and power management processor may be a part of the SoC(s) 904 boot sequence and may provide runtime power management services. The boot power and management processor may provide clock and voltage programming, assistance in system low power state transitions, management of SoC(s) 904 thermals and temperature sensors, and/or management of the SoC(s) 904 power states. Each temperature sensor may be implemented as a ring-oscillator whose output frequency is proportional to temperature, and the SoC(s) 904 may use the ring-oscillators to detect temperatures of the CPU(s) 906, GPU(s) 908, and/or accelerator(s) 914. If temperatures are determined to exceed a threshold, the boot and power management processor may enter a temperature fault routine and put the SoC(s) 904 into a lower power state and/or put the vehicle 900 into a chauffeur to safe stop mode (e.g., bring the vehicle 900 to a safe stop).

The processor(s) 910 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 910 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 910 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 910 may further include a real-time camera engine that may include a dedicated processor subsystem for handling real-time camera management.

The processor(s) 910 may further include a high-dynamic range signal processor that may include an image signal processor that is a hardware engine that is part of the camera processing pipeline.

The processor(s) 910 may include a video image compositor that may be a processing block (e.g., implemented on a microprocessor) that implements video post-processing functions needed by a video playback application to produce the final image for the player window. The video image compositor may perform lens distortion correction on wide-view camera(s) 970, surround camera(s) 974, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 908 is not required to continuously render new surfaces. Even when the GPU(s) 908 is powered on and active doing 3D rendering, the video image compositor may be used to offload the GPU(s) 908 to improve performance and responsiveness.

The SoC(s) 904 may further include a mobile industry processor interface (MIPI) camera serial interface for receiving video and input from cameras, a high-speed interface, and/or a video input block that may be used for camera and related pixel input functions. The SoC(s) 904 may further include an input/output controller(s) that may be controlled by software and may be used for receiving I/O signals that are uncommitted to a specific role.

The SoC(s) 904 may further include a broad range of peripheral interfaces to enable communication with peripherals, audio codecs, power management, and/or other devices. The SoC(s) 904 may be used to process data from cameras (e.g., connected over Gigabit Multimedia Serial Link and Ethernet), sensors (e.g., LIDAR sensor(s) 964, RADAR sensor(s) 960, etc. that may be connected over Ethernet), data from bus 902 (e.g., speed of vehicle 900, steering wheel position, etc.), data from GNSS sensor(s) 958 (e.g., connected over Ethernet or CAN bus). The SoC(s) 904 may further include dedicated high-performance mass storage controllers that may include their own DMA engines, and that may be used to free the CPU(s) 906 from routine data management tasks.

The SoC(s) 904 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 904 may be faster, more reliable, and even more energy-efficient and space-efficient than conventional systems. For example, the accelerator(s) 914, when combined with the CPU(s) 906, the GPU(s) 908, and the data store(s) 916, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 920) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 908.

In some examples, a CNN for facial recognition and vehicle owner identification may use data from camera sensors to identify the presence of an authorized driver and/or owner of the vehicle 900. The always on sensor processing engine may be used to unlock the vehicle when the owner approaches the driver door and turn on the lights, and, in security mode, to disable the vehicle when the owner leaves the vehicle. In this way, the SoC(s) 904 provide for security against theft and/or carjacking.

In another example, a CNN for emergency vehicle detection and identification may use data from microphones 996 to detect and identify emergency vehicle sirens. In contrast to conventional systems, that use general classifiers to detect sirens and manually extract features, the SoC(s) 904 use the CNN for classifying environment and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 958. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 962, until the emergency vehicle(s) passes.

The vehicle may include a CPU(s) 918 (e.g., discrete CPU(s), or dCPU(s)), that may be coupled to the SoC(s) 904 via a high-speed interconnect (e.g., PCIe). The CPU(s) 918 may include an X86 processor, for example. The CPU(s) 918 may be used to perform any of a variety of functions, including arbitrating potentially inconsistent results between ADAS sensors and the SoC(s) 904, and/or monitoring the status and health of the controller(s) 936 and/or infotainment SoC 930, for example.

The vehicle 900 may include a GPU(s) 920 (e.g., discrete GPU(s), or dGPU(s)), that may be coupled to the SoC(s) 904 via a high-speed interconnect (e.g., NVIDIA's NVLINK). The GPU(s) 920 may provide additional artificial intelligence functionality, such as by executing redundant and/or different neural networks, and may be used to train and/or update neural networks based on input (e.g., sensor data) from sensors of the vehicle 900.

The vehicle 900 may further include the network interface 922 which may include one or more wireless antennas 926 (e.g., one or more wireless antennas for different communication protocols, such as a cellular antenna, a Bluetooth antenna, etc.). The network interface 922 may be used to enable wireless connectivity over the Internet with the cloud (e.g., with the server(s) 978 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 900 information about vehicles in proximity to the vehicle 900 (e.g., vehicles in front of, on the side of, and/or behind the vehicle 900). This functionality may be part of a cooperative adaptive cruise control functionality of the vehicle 900.

The network interface 922 may include a SoC that provides modulation and demodulation functionality and enables the controller(s) 936 to communicate over wireless networks. The network interface 922 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 900 may further include data store(s) 928 which may include off-chip (e.g., off the SoC(s) 904) storage. The data store(s) 928 may include one or more storage elements including RAM, SRAM, DRAM, VRAM, Flash, hard disks, and/or other components and/or devices that may store at least one bit of data.

The vehicle 900 may further include GNSS sensor(s) 958. The GNSS sensor(s) 958 (e.g., GPS, assisted GPS sensors, differential GPS (DGPS) sensors, etc.), to assist in mapping, perception, occupancy grid generation, and/or path planning functions. Any number of GNSS sensor(s) 958 may be used, including, for example and without limitation, a GPS using a USB connector with an Ethernet to Serial (RS-232) bridge.

The vehicle 900 may further include RADAR sensor(s) 960. The RADAR sensor(s) 960 may be used by the vehicle 900 for long-range vehicle detection, even in darkness and/or severe weather conditions. RADAR functional safety levels may be ASIL B. The RADAR sensor(s) 960 may use the CAN and/or the bus 902 (e.g., to transmit data generated by the RADAR sensor(s) 960) for control and to access object tracking data, with access to Ethernet to access raw data in some examples. A wide variety of RADAR sensor types may be used. For example, and without limitation, the RADAR sensor(s) 960 may be suitable for front, rear, and side RADAR use. In some example, Pulse Doppler RADAR sensor(s) are used.

The RADAR sensor(s) 960 may include different configurations, such as long range with narrow field of view, short range with wide field of view, short range side coverage, etc. In some examples, long-range RADAR may be used for adaptive cruise control functionality.

The long-range RADAR systems may provide a broad field of view realized by two or more independent scans, such as within a 250 m range. The RADAR sensor(s) 960 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 900 surroundings at higher speeds with minimal interference from traffic in adjacent lanes. The other two antennae may expand the field of view, making it possible to quickly detect vehicles entering or leaving the vehicle's 900 lane.

Mid-range RADAR systems may include, as an example, a range of up to 1260 m (front) or 80 m (rear), and a field of view of up to 42 degrees (front) or 1250 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 900 may further include ultrasonic sensor(s) 962. The ultrasonic sensor(s) 962, which may be positioned at the front, back, and/or the sides of the vehicle 900, may be used for park assist and/or to create and update an occupancy grid. A wide variety of ultrasonic sensor(s) 962 may be used, and different ultrasonic sensor(s) 962 may be used for different ranges of detection (e.g., 2.5 m, 4 m). The ultrasonic sensor(s) 962 may operate at functional safety levels of ASIL B.

The vehicle 900 may include LIDAR sensor(s) 964. The LIDAR sensor(s) 964 may be used for object and pedestrian detection, emergency braking, collision avoidance, and/or other functions. The LIDAR sensor(s) 964 may be functional safety level ASIL B. In some examples, the vehicle 900 may include multiple LIDAR sensors 964 (e.g., two, four, six, etc.) that may use Ethernet (e.g., to provide data to a Gigabit Ethernet switch).

In some examples, the LIDAR sensor(s) 964 may be capable of providing a list of objects and their distances for a 360-degree field of view. Commercially available LIDAR sensor(s) 964 may have an advertised range of approximately 1200 m, with an accuracy of 2 cm-3 cm, and with support for a 1200 Mbps Ethernet connection, for example. In some examples, one or more non-protruding LIDAR sensors 964 may be used. In such examples, the LIDAR sensor(s) 964 may be implemented as a small device that may be embedded into the front, rear, sides, and/or corners of the vehicle 900. The LIDAR sensor(s) 964, in such examples, may provide up to a 120-degree horizontal and 35-degree vertical field-of-view, with a 200 m range even for low-reflectivity objects. Front-mounted LIDAR sensor(s) 964 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 900. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 964 may be less susceptible to motion blur, vibration, and/or shock.

The vehicle may further include IMU sensor(s) 966. The IMU sensor(s) 966 may be located at a center of the rear axle of the vehicle 900, in some examples. The IMU sensor(s) 966 may include, for example and without limitation, an accelerometer(s), a magnetometer(s), a gyroscope(s), a magnetic compass(es), and/or other sensor types. In some examples, such as in six-axis applications, the IMU sensor(s) 966 may include accelerometers and gyroscopes, while in nine-axis applications, the IMU sensor(s) 966 may include accelerometers, gyroscopes, and magnetometers.

In some embodiments, the IMU sensor(s) 966 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 966 may enable the vehicle 900 to estimate heading without requiring input from a magnetic sensor by directly observing and correlating the changes in velocity from GPS to the IMU sensor(s) 966. In some examples, the IMU sensor(s) 966 and the GNSS sensor(s) 958 may be combined in a single integrated unit.

The vehicle may include microphone(s) 996 placed in and/or around the vehicle 900. The microphone(s) 996 may be used for emergency vehicle detection and identification, among other things.

The vehicle may further include any number of camera types, including stereo camera(s) 968, wide-view camera(s) 970, infrared camera(s) 972, surround camera(s) 974, long-range and/or mid-range camera(s) 998, and/or other camera types. The cameras may be used to capture image data around an entire periphery of the vehicle 900. The types of cameras used depends on the embodiments and requirements for the vehicle 900, and any combination of camera types may be used to provide the necessary coverage around the vehicle 900. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 9A and FIG. 9B.

The vehicle 900 may further include vibration sensor(s) 942. The vibration sensor(s) 942 may measure vibrations of components of the vehicle, such as the axle(s). For example, changes in vibrations may indicate a change in road surfaces. In another example, when two or more vibration sensors 942 are used, the differences between the vibrations may be used to determine friction or slippage of the road surface (e.g., when the difference in vibration is between a power-driven axle and a freely rotating axle).

The vehicle 900 may include an ADAS system 938. The ADAS system 938 may include a SoC, in some examples. The ADAS system 938 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 960, LIDAR sensor(s) 964, and/or a camera(s). The ACC systems may include longitudinal ACC and/or lateral ACC. Longitudinal ACC monitors and controls the distance to the vehicle immediately ahead of the vehicle 900 and automatically adjust the vehicle speed to maintain a safe distance from vehicles ahead. Lateral ACC performs distance keeping, and advises the vehicle 900 to change lanes when necessary. Lateral ACC is related to other ADAS applications such as LCA and CWS.

CACC uses information from other vehicles that may be received via the network interface 922 and/or the wireless antenna(s) 926 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 900), while the I2V communication concept provides information about traffic further ahead. CACC systems may include either or both I2V and V2V information sources. Given the information of the vehicles ahead of the vehicle 900, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 960, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 960, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 900 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 900 if the vehicle 900 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 960, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 900 is backing up. Some RCTW systems include AEB to ensure that the vehicle brakes are applied to avoid a crash. RCTW systems may use one or more rear-facing RADAR sensor(s) 960, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 900, the vehicle 900 itself must, in the case of conflicting results, decide whether to heed the result from a primary computer or a secondary computer (e.g., a first controller 936 or a second controller 936). For example, in some embodiments, the ADAS system 938 may be a backup and/or secondary computer for providing perception information to a backup computer rationality module. The backup computer rationality monitor may run a redundant diverse software on hardware components to detect faults in perception and dynamic driving tasks. Outputs from the ADAS system 938 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 904.

In other examples, ADAS system 938 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 938 may be fed into the primary computer's perception block and/or the primary computer's dynamic driving task block. For example, if the ADAS system 938 indicates a forward crash warning due to an object immediately ahead, the perception block may use this information when identifying objects. In other examples, the secondary computer may have its own neural network which is trained and thus reduces the risk of false positives, as described herein.

The vehicle 900 may further include the infotainment SoC 930 (e.g., an in-vehicle infotainment system (IVI)). Although illustrated and described as a SoC, the infotainment system may not be a SoC, and may include two or more discrete components. The infotainment SoC 930 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 900. For example, the infotainment SoC 930 may radios, disk players, navigation systems, video players, USB and Bluetooth connectivity, carputers, in-car entertainment, Wi-Fi, steering wheel audio controls, hands free voice control, a heads-up display (HUD), an HMI display 934, a telematics device, a control panel (e.g., for controlling and/or interacting with various components, features, and/or systems), and/or other components. The infotainment SoC 930 may further be used to provide information (e.g., visual and/or audible) to a user(s) of the vehicle, such as information from the ADAS system 938, autonomous driving information such as planned vehicle maneuvers, trajectories, surrounding environment information (e.g., intersection information, vehicle information, road information, etc.), and/or other information.

The infotainment SoC 930 may include GPU functionality. The infotainment SoC 930 may communicate over the bus 902 (e.g., CAN bus, Ethernet, etc.) with other devices, systems, and/or components of the vehicle 900. In some examples, the infotainment SoC 930 may be coupled to a supervisory MCU such that the GPU of the infotainment system may perform some self-driving functions in the event that the primary controller(s) 936 (e.g., the primary and/or backup computers of the vehicle 900) fail. In such an example, the infotainment SoC 930 may put the vehicle 900 into a chauffeur to safe stop mode, as described herein.

The vehicle 900 may further include an instrument cluster 932 (e.g., a digital dash, an electronic instrument cluster, a digital instrument panel, etc.). The instrument cluster 932 may include a controller and/or supercomputer (e.g., a discrete controller or supercomputer). The instrument cluster 932 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 930 and the instrument cluster 932. In other words, the instrument cluster 932 may be included as part of the infotainment SoC 930, or vice versa.

FIG. 9D is a system diagram for communication between cloud-based server(s) and the example autonomous vehicle 900 of FIG. 9A, in accordance with some embodiments of the present disclosure. The system 976 may include server(s) 978, network(s) 990, and vehicles, including the vehicle 900. The server(s) 978 may include a plurality of GPUs 984(A)-984(H) (collectively referred to herein as GPUs 984), PCIe switches 982(A)-982(H) (collectively referred to herein as PCIe switches 982), and/or CPUs 980(A)-980(B) (collectively referred to herein as CPUs 980). The GPUs 984, the CPUs 980, and the PCIe switches may be interconnected with high-speed interconnects such as, for example and without limitation, NVLink interfaces 988 developed by NVIDIA and/or PCIe connections 986. In some examples, the GPUs 984 are connected via NVLink and/or NVSwitch SoC and the GPUs 984 and the PCIe switches 982 are connected via PCIe interconnects. Although eight GPUs 984, two CPUs 980, and two PCIe switches are illustrated, this is not intended to be limiting. Depending on the embodiment, each of the server(s) 978 may include any number of GPUs 984, CPUs 980, and/or PCIe switches. For example, the server(s) 978 may each include eight, sixteen, thirty-two, and/or more GPUs 984.

The server(s) 978 may receive, over the network(s) 990 and from the vehicles, image data representative of images showing unexpected or changed road conditions, such as recently commenced road-work. The server(s) 978 may transmit, over the network(s) 990 and to the vehicles, neural networks 992, updated neural networks 992, and/or map information 994, including information regarding traffic and road conditions. The updates to the map information 994 may include updates for the HD map 922, such as information regarding construction sites, potholes, detours, flooding, and/or other obstructions. In some examples, the neural networks 992, the updated neural networks 992, and/or the map information 994 may have resulted from new training and/or experiences represented in data received from any number of vehicles in the environment, and/or based on training performed at a datacenter (e.g., using the server(s) 978 and/or other servers).

The server(s) 978 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 990, and/or the machine learning models may be used by the server(s) 978 to remotely monitor the vehicles.

In some examples, the server(s) 978 may receive data from the vehicles and apply the data to up-to-date real-time neural networks for real-time intelligent inferencing. The server(s) 978 may include deep-learning supercomputers and/or dedicated AI computers powered by GPU(s) 984, such as a DGX and DGX Station machines developed by NVIDIA. However, in some examples, the server(s) 978 may include deep learning infrastructure that use only CPU-powered datacenters.

The deep-learning infrastructure of the server(s) 978 may be capable of fast, real-time inferencing, and may use that capability to evaluate and verify the health of the processors, software, and/or associated hardware in the vehicle 900. For example, the deep-learning infrastructure may receive periodic updates from the vehicle 900, such as a sequence of images and/or objects that the vehicle 900 has located in that sequence of images (e.g., via computer vision and/or other machine learning object classification techniques). The deep-learning infrastructure may run its own neural network to identify the objects and compare them with the objects identified by the vehicle 900 and, if the results do not match and the infrastructure concludes that the AI in the vehicle 900 is malfunctioning, the server(s) 978 may transmit a signal to the vehicle 900 instructing a fail-safe computer of the vehicle 900 to assume control, notify the passengers, and complete a safe parking maneuver.

For inferencing, the server(s) 978 may include the GPU(s) 984 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that enable the computing device 1000 to communicate with other computing devices via an electronic communication network, included wired and/or wireless communications. The communication interface 1010 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may enable the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that enable detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to enable the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1133, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may utilize distributed file system 1138 for large-scale data processing (e.g., “big data”). In at least one embodiment, job scheduler 1133 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1133. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
receiving road data representing road sections and lane data representing a lane associated with a location of an ego-machine;
determining that consecutive road sections match a lane based at least on a geometric similarity between the lane and the consecutive road sections; and
generating a representation of the lane being mapped to the consecutive road sections based at least on the determining that the consecutive road sections matched the lane; and
performing one or more operations corresponding to the ego-machine based at least on the representation of the lane mapped to the consecutive road sections.

2. The method of claim 1, wherein the determining that the consecutive road sections matched the lane based at least on the geometric similarity comprises determining that the lane is positioned within a distance threshold of one or more points along the consecutive road sections.

3. The method of claim 1, wherein the determining the consecutive road sections that match the lane based at least on the geometric similarity comprises determining the lane is positioned within a direction threshold of one or more points along the consecutive road sections.

4. The method of claim 1, wherein the determining the consecutive road sections that match the lane based at least on the geometric similarity comprises determining the lane is positioned within a distance threshold and a direction threshold of one or more points along the consecutive road sections.

5. The method of claim 1, wherein the determining the consecutive road sections that match the lane based at least on the geometric similarity comprises iteratively determining that one or more points along the consecutive road sections are positioned within a distance threshold of the lane based at least on extending one or more perpendicular line segments from the one or more points along the consecutive road sections to intersect with the lane.

6. The method of claim 5, wherein the one or more points along the consecutive road sections are positioned a predetermined distance between consecutive points of the one or more points.

7. The method of claim 1, wherein the determining the consecutive road sections that match the lane based at least on the geometric similarity comprises determining the lane is positioned within a distance threshold and a direction threshold for at least a predetermined number of points along the consecutive road sections.

8. The method of claim 1, wherein the determining the consecutive road sections that match the lane based at least on the geometric similarity comprises determining the lane is positioned within a distance threshold and a direction threshold for one or more points positioned along the consecutive road sections for at least a predetermined distance.

9. The method of claim 1, further comprising generating a representation of an extent to which the consecutive road sections match the lane based at least on the geometric similarity between the lane and the consecutive road sections.

10. The method of claim 1, wherein the generating the representation of the extent of which the consecutive road sections match the lane is based at least on a sum of one or more inverses of one or more distances between the lane and one or more sampled locations along the consecutive road sections.

11. The method of claim 1, further comprising determining to generate the representation of the lane being mapped to the consecutive road sections based at least on a representation of an extent to which the consecutive road sections match the lane being greater than another representation of an extent to which other consecutive road sections match the lane.

12. The method of claim 1, wherein the representation of the lane mapped to the consecutive road sections comprises a representation of a start and end location of a section along the lane, a representation of an identity of at least a portion of the consecutive road sections, and a representation of a start and end location of at least one road section.

13. The method of claim 1, further comprising selecting the lane based at least on the lane having a position along its geometry within a maximum distance from the location of the ego-machine.

14. The method of claim 1, wherein the method is performed using at least one of:
a control system for an autonomous or semi-autonomous machine;
a perception system for an autonomous or semi-autonomous machine;
a system for performing simulation operations;
a system for performing real-time streaming;
a system for generating or presenting one or more of augmented reality content, virtual reality content, or mixed reality content;
a system for performing digital twin operations;
a system for performing deep learning operations;
a system implemented using an edge device;
a system implemented using a robot;
a system incorporating one or more virtual machines (VMs);
a system implemented at least partially in a data center;
a system for performing light transport simulation;
a system for performing collaborative content creation for 3D assets;
a system for generating synthetic data; or
a system implemented at least partially using cloud computing resources.

15. One or more processors comprising processing circuitry to:
determine that one or more consecutive road sections detected by an ego-machine match a lane detected by the ego-machine based at least on a geometric similarity between the lane and the one or more consecutive road sections; and
generate a representation of the lane being mapped to the one or more consecutive road sections based at least on the determining that the one or more consecutive road sections matched the lane.

16. The one or more processors of claim 15, wherein the determining the one or more consecutive road sections that match the lane based at least on the geometric similarity comprises an iterative process of determining the lane is positioned within a distance threshold and a direction threshold of a sequence of one or more points along the one or more consecutive road sections.

17. The one or more processors of claim 15, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

18. A system comprising one or more processors to:
determine a road section of a road-graph associated with an ego-machine matches a lane of a lane-graph associated with the ego-machine based at least on a geometric similarity between the lane and the road section;
generate a representation of an extent to which the road section matches the lane based at least on the geometric similarity between the lane and the road section;
generate a representation of the lane mapped to the road section based at least on the representation of the extent to which the road section matches the lane; and
performing one or more operations associated with control of the ego-machine based at least on the representation of the lane mapped to the road section.

19. The system of claim 18, wherein the representation of the extent of which the road section matches the lane is generated based at least on a sum of one or more inverses of one or more distances between the lane and one or more sampled locations along the road section.

20. The system of claim 18, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
